(19) United States
(12) Patent Application Publication
(10) Pub. No.: US 2026/0303794 A1
(43) Pub. Date: Oct. 1, 2026

(54) ADAPTIVE INTRA BLOCK COPY FILTERING

(71) Applicant: TENCENT TECHNOLOGY (SHENZHEN) COMPANY LIMITED, Shenzhen (CN)

(72) Inventors: Yingbin WANG, Shenzhen (CN); Liqiang WANG, Shenzhen (CN); Xiaozhong XU, Shenzhen (CN)

(73) Assignee: TENCENT TECHNOLOGY (SHENZHEN) COMPANY LIMITED, Shenzhen (CN)

(21) Appl. No.: 19/688,475

(22) Filed: May 26, 2026

Related U.S. Application Data
(63) Continuation of application No. PCT/CN2025/082105, filed on Mar. 12, 2025.

(30) Foreign Application Priority Data
Mar. 19, 2024 (CN) 202410334152.9

(51) Int. Cl. H04N 19/117; H04N 19/105; H04N 19/132; H04N 19/157; H04N 19/172; H04N 19/176; H04N 19/18; H04N 19/182; H04N 19/46; H04N 19/593

(52) U.S. Cl. CPC H04N 19/117; H04N 19/105; H04N 19/132; H04N 19/157; H04N 19/172; H04N 19/176; H04N 19/18; H04N 19/182; H04N 19/46; H04N 19/593

(57) ABSTRACT

Intra block copy prediction is performed on a current block according to a reference block of the current block to obtain a first predicted value of the current block in a current video frame. A first template region of the reference block and a second template region of the current block are determined. The first template region includes one or more reconstructed image regions adjacent to the reference block, and the second template region includes one or more reconstructed image regions adjacent to the current block. A filter is determined according to the first template region and the second template region. Filtering processing is performed on the first predicted value of the current block according to the filter to obtain a second predicted value of the current block. The current block is reconstructed based on a weighted combination of the first predicted value and the second predicted value.

### RELATED APPLICATIONS

The present application is a continuation of International Application No. PCT/CN2025/082105, filed on Mar. 12, 2025, which claims priority to Chinese Patent Application No. 202410334152.9, filed on Mar. 19, 2024. The entire disclosures of the prior applications are hereby incorporated by reference.

### FIELD OF THE TECHNOLOGY

This disclosure relates to video coding and decoding technologies, including methods of adaptive intra block copy (IBC) filtering.

### BACKGROUND

To adapt to large-scale data transmission of audio and video data, original audio and video data is usually coded on a data transmit end to form compressed data streams. After the data streams are transmitted to a data receive end, the data streams are decoded and restored, to obtain the audio and video data constructed through prediction.

Related video coding and decoding solutions include various prediction coding and decoding technologies, for example, intra prediction, inter prediction, and intra block copy (IBC) prediction. In the IBC technology, a predicted value (a predicted block) of a current block in a current video frame is exported by using a constructed region in the current video frame as a reference. However, in the IBC technology, boundary of the current block reconstructed according to the predicted block and surrounding pixels are prone to be discontinuous. As a result, quality of an image obtained through decoding is poor.

### SUMMARY

This disclosure includes a video processing method, a video processing apparatus, a computer readable medium, an electronic device, and a computer program product, so as to improve coding and decoding quality of audio and video data.

According to an aspect of the disclosure, a method of video decoding is provided. In the method, intra block copy prediction is performed on a current block according to a reference block of the current block to obtain a first predicted value of the current block. The current block is a to-be-processed image block in a current video frame, and the reference block is a reconstructed image block in the current video frame. A first template region of the reference block and a second template region of the current block are determined. The first template region includes one or more reconstructed image regions adjacent to the reference block, and the second template region includes one or more reconstructed image regions adjacent to the current block. A filter is determined according to the first template region and the second template region. Filtering processing is performed on the first predicted value of the current block according to the filter to obtain a second predicted value of the current block. The current block is reconstructed based on a weighted combination of the first predicted value and the second predicted value.

According to an aspect of the disclosure, a method of video encoding is provided. In the method, intra block copy prediction is performed on a current block according to a reference block of the current block to obtain a first predicted value of the current block. The current block is a to-be-processed image block in a current video frame, and the reference block is a reconstructed image block in the current video frame. A first template region of the reference block and a second template region of the current block are determined. The first template region includes one or more reconstructed image regions adjacent to the reference block, and the second template region includes one or more reconstructed image regions adjacent to the current block. A filter is determined according to the first template region and the second template region. Filtering processing is performed on the first predicted value of the current block according to the filter to obtain a second predicted value of the current block. The current block is encoded in a bitstream based on a weighted combination of the first predicted value and the second predicted value.

Aspects of the disclosure also provide an apparatus for video decoding. The apparatus for video decoding includes processing circuitry configured to implement any of the described methods for video decoding.

Aspects of the disclosure also provide an apparatus for video encoding. The apparatus for video encoding includes processing circuitry configured to implement any of the described methods for video encoding.

Aspects of the disclosure also provide a non-transitory computer-readable medium storing instructions which, when executed by a processor, cause the processor to perform any of the described methods.

According to an aspect of this disclosure, a video processing method is provided, including: performing intra block copy prediction on a current block according to a reference block of the current block, to obtain a first predicted value of the current block, the current block being a to-be-processed image block in a current video frame, and the reference block being a reconstructed image block in the current video frame; determining a first template region of the reference block and a second template region of the current block, the first template region including one or more reconstructed image regions adjacent to the reference block, and the second template region including one or more reconstructed image regions adjacent to the current block; and determining a filter according to the first template region and the second template region, and performing filtering processing on the first predicted value of the current block according to the filter, to obtain a second predicted value of the current block.

According to an aspect of this disclosure, a video processing apparatus is provided, including: a prediction module, configured to perform intra block copy prediction on a current block according to a reference block of the current block, to obtain a first predicted value of the current block, the current block being a to-be-processed image block in a current video frame, and the reference block being a reconstructed image block in the current video frame; a determining module, configured to determine a first template region of the reference block and a second template region of the current block, the first template region including one or more reconstructed image regions adjacent to the reference block, and the second template region including one or more reconstructed image regions adjacent to the current block; and a filtering module, configured to: determine a filter according to the first template region and the second template region, and perform filtering processing on the first predicted value of the current block according to the filter, to obtain a second predicted value of the current block.

According to an aspect of this disclosure, a computer-readable medium is provided, having a computer program stored therein, the computer program being executed by a processor to implement the video processing method in the foregoing technical solutions.

According to an aspect of this disclosure, an electronic device is provided, including: a processor, and a memory, configured to store executable instructions of the processor, the processor being configured to execute the executable instructions to implement the video processing method in the foregoing technical solutions.

According to an aspect of disclosure, a computer program product is provided, including a computer program, the computer program being executed by a processor to implement the video processing method in the foregoing technical solutions.

A video stream storing or sending method is provided. A video stream may be generated according to the foregoing video processing method or may be decoded.

In technical solutions provided in aspects of this disclosure, intra block copy prediction may be performed on a current block according to a reference block of the current block, to obtain a first predicted value of the current block, a filter may be determined according to the first template region of the reference block and the second template region of the current block, and filtering processing may be performed on the first predicted value of the current block according to the filter, to obtain a second predicted value of the current block. The filter is determined to perform filtering processing on the first predicted value of the current block, so that space domain discontinuity between a predicted block (the first predicted value) of the current block and surrounding pixels can be eliminated or reduced, thereby improving image coding and decoding quality.

### BRIEF DESCRIPTION OF THE DRAWINGS

Accompanying drawings herein are incorporated into the specification and constitute a part of this specification, show aspects that conform to this disclosure, and are used for explaining the principle of this disclosure together with this specification. The accompanying drawings described below are merely some aspects of this disclosure, and a person of ordinary skill in the art may further obtain other accompanying drawings according to these accompanying drawings.

FIG. 1 is a schematic diagram of a system architecture applicable to a technical solution of an aspect of this disclosure;

FIG. 2 shows a mode of deploying a video coding apparatus and a video decoding apparatus in a streaming transmission environment according to an aspect of this disclosure;

FIG. 3 is a basic flowchart of a coding process performed by a video encoder according to an aspect of this disclosure;

FIG. 4 is a schematic diagram of a principle of an inter prediction mode according to an aspect of this disclosure;

FIG. 5 is a schematic diagram of a principle of an intra block copy prediction mode according to an aspect of this disclosure;

FIG. 6A is a flowchart of a video processing method according to an aspect of this disclosure;

FIG. 6B is a schematic diagram of a video processing method according to an aspect of this disclosure;

FIG. 7A is a schematic diagram of a corresponding form of samples related to a filter according to an aspect of this disclosure;

FIG. 7B is a schematic diagram of determining a filter parameter according to an aspect of this disclosure;

FIG. 7C is a schematic diagram of using a filter according to an aspect of this disclosure;

FIG. 8 is a schematic diagram of a shape of a filter used in some application scenarios according to an aspect of this disclosure;

FIG. 9 is a schematic diagram of selecting a sampling location based on location coordinates of a pixel according to an aspect of this disclosure;

FIG. 10 is a schematic diagram of selecting a sampling location based on a round-trip scanning manner according to an aspect of this disclosure;

FIG. 11 is a schematic diagram of selecting a sampling location based on a ZigZag scanning manner according to an aspect of this disclosure;

FIG. 12 is a schematic diagram of distribution of a template region corresponding to an image block according to an aspect of this disclosure;

FIG. 13 is a schematic diagram of types of forming different template regions with both some sub-regions and image blocks according to an aspect of this disclosure;

FIG. 14 is a schematic diagram of a template region selected for an image block according to an aspect of this disclosure;

FIG. 15 is a schematic diagram of distribution of a template region used in an application scenario according to an aspect of this disclosure;

FIG. 16 is a schematic diagram of an effect of template region padding in an application scenario according to an aspect of this disclosure;

FIG. 17 is a structural block diagram of a video processing apparatus according to an aspect of this disclosure; and

FIG. 18 is a structural block diagram of a computer system suitable for implementing an electronic device according to an aspect of this disclosure.

### DETAILED DESCRIPTION

Examples of implementations are now to be described with reference to the accompanying drawings. However, the examples of the implementations may be implemented in various forms, and are not to be understood as being limited to the examples described herein. Instead, the implementations are provided to convey the idea of the examples of the implementations to a person skilled in the art.

In addition, the described features, structures, or characteristics may be combined in one or more aspects in any proper manner. In the following descriptions, details are provided for understanding of the aspects of this disclosure. However, a person skilled in the art is to be aware that, the technical solutions in this disclosure may be implemented without one or more of the details, or may be implemented by using another method, unit, apparatus, operation, or the like.

In the aspects of this disclosure, a term “module” or “unit” refers to a computer program having a predetermined function or a part of a computer program, and operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

The block diagrams shown in the accompanying drawings are merely functional entities and do not necessarily correspond to physically independent entities. That is, the functional entities may be implemented in a software form, or in one or more hardware modules or integrated circuits, or in different networks and/or processor apparatuses and/or microcontroller apparatuses.

The flowcharts shown in the accompanying drawings are merely examples of descriptions, do not need to include all content and operations/operations, and do not need to be performed in the described orders either. For example, some operations may be further divided, while some operations may be combined or partially combined. Therefore, an actual execution order may change according to an actual case.

Video coding usually refers to coding a picture sequence forming a video or a video sequence. In the field of video coding, terms “picture”, “frame”, or “image” may be used as synonyms. Video coding used in the aspects of this disclosure indicates video coding or video decoding. Video coding is performed on a video source side, and usually includes processing (for example, compressing) an original video image, to reduce a data volume required for representing the video image, to facilitate more efficient storing and/or transmission. Video decoding is performed on a destination side, and usually includes performing inverse processing relative to an encoder, to reconstruct a video image. In the aspects, “coding” of a video frame is understood as “coding” or “decoding” of a video image sequence. A combination of a coding part and a decoding part is also referred to as codec (coding and decoding).

Each image in a video image sequence is usually divided into a non-overlapping block set, and coding is usually performed at a block level. In other words, an encoder side usually processes/encodes a video at a block (also referred to as an image block or a video block) level. For example, space (intra-image) prediction and/or time (inter-image) prediction is performed on a current block (a block being processed currently or a to-be-processed block), to generate a predicted block of the current block, the predicted block is subtracted from the current block to obtain a residual block, and the residual block is transformed in transform domain and the residual block is quantized, so as to reduce a to-be-transmitted (compressed) data volume. A decoder side applies inverse processing relative to the encoder to the coded or compressed current block, to reconstruct the current block. In addition, the encoder copies a processing cycle of the decoder, so that the encoder and the decoder generate the same prediction (for example, intra prediction and inter prediction) and/or reconstruction for the same block, to process/encode a subsequent block.

Examples of terms involved in the aspects of the disclosure are briefly introduced. The descriptions of the terms are provided as examples only and are not intended to limit the scope of the disclosure.

The term “block” is a part of an image or a frame. In the aspects of this disclosure, the current block is a block that is being processed currently. For example, during coding, the current block refers to a block that is being coded currently. During decoding, the current block refers to a block that is being currently decoded.

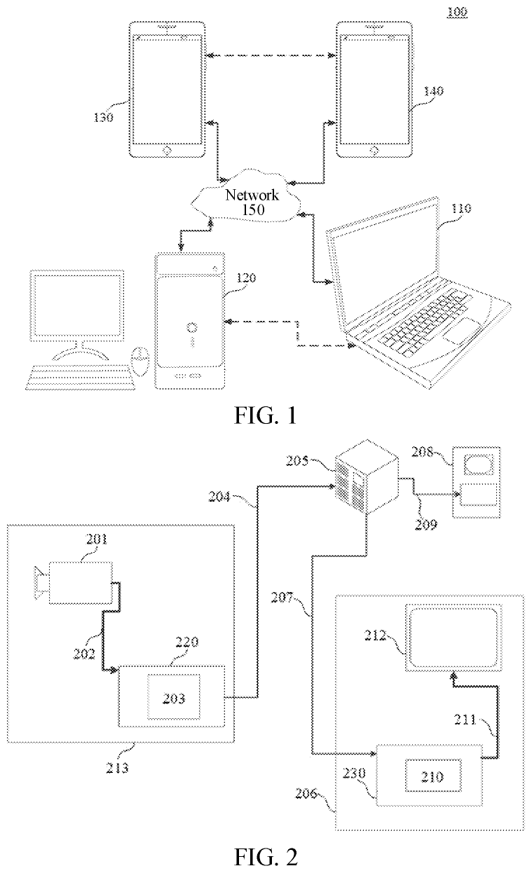

FIG. 1 is a schematic diagram of a system architecture applicable to a technical solution of an aspect of this disclosure.

As shown in FIG. 1, a system architecture 100 includes a plurality of terminal apparatuses. The terminal apparatuses may communicate with each other, for example, through a network 150. For example, the system architecture 100 may include a first terminal apparatus 110 and a second terminal apparatus 120 that are interconnected through the network 150. In the aspect of FIG. 1, the first terminal apparatus 110 and the second terminal apparatus 120 perform unidirectional data transmission.

For example, the first terminal apparatus 110 may encode video data (such as a video picture stream collected by the terminal apparatus 110) and transmit the coded video data to the second terminal apparatus 120 through the network 150. The coded video data is transmitted in the form of one or more coded video streams. The second terminal apparatus 120 may receive the coded video data through the network 150, decode the coded video data to restore the video data, and display video pictures according to the restored video data.

In some aspects of this disclosure, the system architecture 100 may include a third terminal apparatus 130 and a fourth terminal apparatus 140 that perform bidirectional transmission on coded video data. The bidirectional transmission may occur, for example, during a video meeting. For bidirectional data transmission, one of the third terminal apparatus 130 and the fourth terminal apparatus 140 may encode video data (such as a video picture stream collected by the terminal apparatus) and transmit the encode video data to the other one of the third terminal apparatus 130 and the fourth terminal apparatus 140 through the network 150. One of the third terminal apparatus 130 and the fourth terminal apparatus 140 may further receive the coded video data transmitted by the other one of the third terminal apparatus 130 and the fourth terminal apparatus 140, decode the coded video data to restore the video data, and display video pictures on an accessible display apparatus according to the restored video data.

In FIG. 1, the first terminal apparatus 110, the second terminal apparatus 120, the third terminal apparatus 130, and the fourth terminal apparatus 140 may be servers, personal computers, and smartphones, but the principles disclosed in this disclosure are not limited thereto. The aspects disclosed in this disclosure are applicable to a laptop computer, a tablet computer, a media player, and/or a dedicated video conference device. The network 150 represents any quantity of networks that transmit the coded video data among the first terminal apparatus 110, the second terminal apparatus 120, the third terminal apparatus 130, and the fourth terminal apparatus 140, and includes, for example, wired and/or wireless communication networks. The communication network 150 may exchange data in circuit-switched and/or packet-switched channels. The network may include a telecommunication network, a local area network, a wide area network, and/or the Internet. For the purpose of this disclosure, unless explained below, an architecture and a topology of the network 150 may be inconsequential to operations disclosed in this disclosure.

FIG. 2 shows a mode of deploying a video coding apparatus and a video decoding apparatus in a streaming transmission environment according to an aspect of this disclosure. The subject matter disclosed in this disclosure may be equally applicable to other video-enabled applications, including, for example, video meeting, a digital television (TV), and storage of compressed videos on a digital medium including a CD, a DVD, a memory stick, and the like.

A streaming transmission system may include a capture subsystem 213. The capture subsystem 213 may include a video source 201 such as a digital camera. The video source creates a video picture stream 202 that is uncompressed. In the aspects, the video picture stream 202 includes a sample taken by the digital camera. The video picture stream 202 is depicted as a bold line to emphasize the video picture stream with a high data volume when compared to coded video data 204 (or a coded video stream 204). The video picture stream 202 may be processed by an electronic apparatus 220. The electronic apparatus 220 includes a video coding apparatus 203 coupled to the video source 201. The video coding apparatus 203 may include hardware, software, or a combination of software and hardware, to implement or perform each aspect of the disclosed subject matter described in more detail below. The coded video data 204 (or the coded video stream 204) is depicted as a thin line to emphasize the coded video data 204 (or the coded video stream 204) with a low data volume when compared to the video picture stream 202, and may be stored on a streaming transmission server 205 for future use. One or more streaming transmission client subsystems, such as a client subsystem 206 and a client subsystem 208 in FIG. 2, may access the streaming transmission server 205 to retrieve a copy 207 and a copy 209 of the coded video data 204. The client subsystem 206 may include, for example, a video decoding apparatus 210 in an electronic apparatus 230. The video decoding apparatus 210 decodes the input copy 207 of the coded video data, and generates an output video picture stream 211 that may be displayed on a display 212 (such as a display screen) or another display apparatus. In some streaming transmission systems, the coded video data 204, video data 207, and video data 209 (such as video streams) may be coded according to some video coding/compression standards.

The electronic apparatus 220 and the electronic apparatus 230 may include other components not shown. For example, the electronic apparatus 220 may include a video decoding apparatus, and the electronic apparatus 230 may further include a video coding apparatus.

In aspects of this disclosure, international video coding standards, that is, high efficiency video coding (HEVC/H.265) and versatile video coding (VVC/H.266), and a Chinese national video coding standard, that is, audio video coding standard (AVS), are used as examples. After being inputted, a video frame image is divided into a plurality of non-overlapping processing units according to a block size, and a similar compression operation is performed on each processing unit. The processing unit is referred to as a coding tree unit (CTU) or a largest coding unit (LCU). The CTU may be further divided into one or more basic coding units (CU). The CU is the most basic element in a coding process.

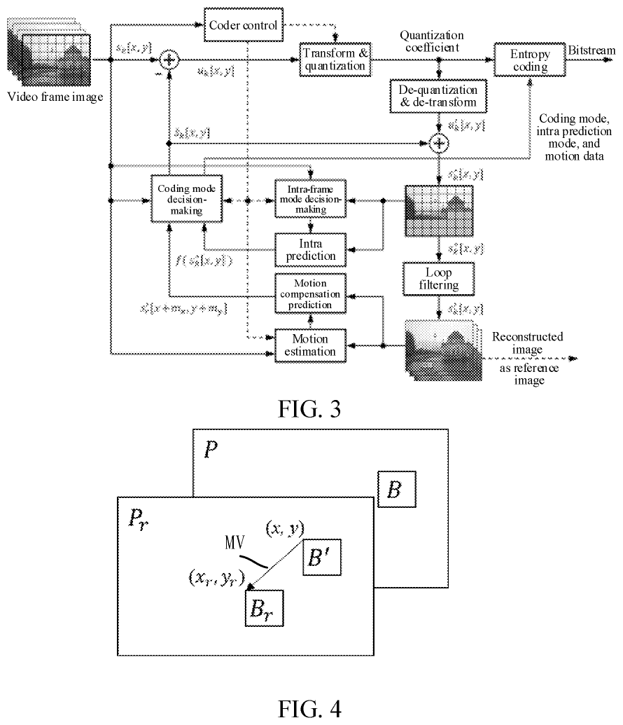

FIG. 3 is a basic flowchart of a coding process performed by a video encoder according to an aspect of this disclosure. In this process, intra prediction is used as an example for description.

A difference operation is performed on an original image signal sₖ[x, y] and a predicted image signal ŝₖ[x, y], to obtain a residual signal uₖ[x, y]. After the residual signal uₖ[x, y] is subject to transform and quantization processing, a quantization coefficient is obtained. For the quantization coefficient, on one hand, entropy coding is performed to obtain a coded bitstream, and on the other hand, de-quantization and de-transform processing are performed to obtain a reconstructed residual signal u′ₖ[x, y]. The predicted image signal ŝₖ[x, y] and the reconstructed residual signal u′ₖ[x, y] are superimposed to generate an image signal sₖ*[x, y]. On one hand, the image signal sₖ*[x, y] is inputted to an intra-frame mode decision-making module and an intra prediction module for intra prediction processing, and on the other hand, a reconstructed image signal s′ₖ[x, y] is outputted through loop filtering. The constructed image signal s′ₖ[x, y] may be used as a reference image of a next frame, to perform motion estimation and motion compensation prediction. Then, a predicted image signal ŝₖ[x, y] of the next frame is obtained based on a motion compensation prediction result s′ᵣ[x+mₓ, y+m_{y}] and an intra prediction result f(sₖ*[x, y]). The foregoing process is repeated until coding is completed.

A coding operation for each CU in the foregoing video coding process is described in further detail as follows:

In an example, the coding operation includes predictive coding. The predictive coding may include manners such as intra prediction and inter prediction. After an original image signal is predicted based on a selected reconstructed image signal, a predicted image signal is obtained. A coding end determines a predictive coding mode to be selected for a current CU, and notifies a decoding end. Intra prediction means that a signal used for predicting a current CU is from an already coded region in the same image as the current CU. Inter prediction means that a signal used for predicting a current CU is from another coded image (referred to as a reference image or a reference frame) different from a current image (a current video frame) in which the current CU is located.

In an example, the coding operation includes transform & quantization. The transform operation, such as discrete Fourier transform (DFT) or discrete cosine transform (DCT), is performed on a residual video signal to convert the signal into a transform domain, to obtain a transform domain signal, which is referred to as a transform coefficient. Then, a lossy quantization operation is performed on the transform coefficient to lose an amount of information, so that the quantized signal is conductive to compressed expression. In some video coding standards, more than one transform mode may be selected. Therefore, a coding end may select one of the transform modes for a current CU, and inform a decoding end. Quantization fineness usually depends on a quantization parameter (QP). A larger QP indicates that coefficients within a larger value range are to be quantized to the same output, which usually brings greater distortion and a lower bit rate. On the contrary, a smaller QP indicates that coefficients within a smaller value range are to be quantized to the same output, which usually brings less distortion and a higher bit rate.

In an example, the coding operation may include entropy coding or statistical coding. The statistical compression coding is performed on the quantized transform domain signal according to a frequency of occurrence of each value in the signal, and finally a binarized (0 or 1) compressed stream is outputted. In addition, entropy coding also needs to be performed on other information generated through coding, such as a selected coding mode and motion vector data, to reduce the bit rate. Statistical coding is a lossless coding mode that can effectively reduce a bit rate required to express the same signal. A related statistical coding mode includes variable length coding (VLC) or context adaptive binary arithmetic coding (CABAC).

A CABAC process may include three operations: binarization, context modeling, and binary arithmetic coding. After an inputted syntax element is binarized, binary data may be coded in a normal coding mode and a bypass coding mode. In the bypass coding mode, a probability model does not need to be assigned to each binary bit, and an inputted binary bit bin value is directly coded by using a simple bypass encoder to speed up the entire coding and decoding. In an example, different syntax elements are not entirely independent of each other, and the same syntax element has a memory property. Therefore, according to a conditional entropy theory, conditional coding performed based on other coded syntax elements can further improve the coding performance compared to independent coding or memoryless coding. Such coded symbolic information serving as a condition is referred to as a context. In a related coding mode, binary bits of a syntax element sequentially enter a context model. The encoder assigns an appropriate probability model for each inputted binary bit according to a value of a previously coded syntax element or binary bit. This process is referred to as context modeling. A context model corresponding to a syntax element may be located based on a context index increment (ctxIdxInc) and a context index start (ctxIdxStart). After the bin value and the assigned probability model are inputted together into a binary arithmetic encoder for coding, the context model is updated according to the bin value. This is an adaptive process during coding.

The coding operation may include loop filtering. In the loop filtering, a reconstructed image is obtained based on a transformed and quantized signal through operations of de-quantization, de-transform, and prediction compensation. The reconstructed image has some information different from that in an original image as a result of quantization, that is, the reconstructed image may cause distortion. Therefore, a filtering operation may be performed on the reconstructed image. Therefore, a filter such as a deblocking filter (DB), a sample adaptive offset (SAO) filter, or an adaptive loop filter (ALF) can effectively reduce a degree of distortion caused by quantization. Since the filtered reconstructed images are used as a reference for subsequent coded images to predict future image signals, the filtering operation is also referred to as loop filtering, that is, filtering operation in a coding loop.

Based on the foregoing coding process, for each CU, after a compressed stream (that is, a bitstream) is obtained, a decoding end performs entropy decoding to obtain various mode information and a quantization coefficient. Then, de-quantization and de-transform are performed on the quantization coefficient to obtain a residual signal corresponding to the CU. In addition, a predicted signal corresponding to the CU may be obtained based on known coding mode information. Then, the residual signal and the predicted signal may be added to obtain a reconstructed signal. The reconstructed signal is then subject to operations such as loop filtering to generate a final output signal.

Currently, mainstream video coding standards such as HEVC, VVC, AVS3, AV1, and AV2 all use a block-based hybrid coding framework. Original video data is divided into a series of coding blocks, and video data compression may be implemented by using a video coding method such as prediction, transform, and entropy coding.

Motion compensation is a related type of prediction method for video coding. Motion compensation derives a predicted value of a current coding block from a coded region based on a redundancy feature of video content in a time domain or a space domain. Such prediction methods include: inter prediction, intra block copy prediction, intra string copy prediction, and the like. During coding implementation, these prediction methods may be used alone or in combination. For a coding block using these prediction methods, one or more two-dimensional displacement vectors may need to be explicitly or implicitly coded in a stream, and indicate a displacement of a current block (or a co-located block of the current block) relative to one or more reference blocks of the current block.

In different prediction modes and different implementations, the displacement vectors may have different names and are described in this specification in the following manner: (1) a displacement vector in inter prediction is referred to as a motion vector (MV); (2) a displacement vector in intra block copy prediction is referred to as a block vector (BV); and (3) a displacement vector in intra string copy is referred to as a string vector (SV). The following describes related technologies in inter prediction and intra block copy prediction.

FIG. 4 is a schematic diagram of a principle of an inter prediction mode according to an aspect of this disclosure. As shown in FIG. 4, in the inter prediction mode, according to correlation of a video in time domain, a pixel of a current image is predicted based on a pixel of an adjacent coded image, so that time domain redundancy of the video can be effectively reduced and coding bits of residual data can be effectively reduced. As shown in FIG. 4. P is a current video frame, Pr is a reference frame, B is a current to-be-coded block, and Br is a reference block of B. A coordinate location of Br in the reference frame Pr is the same as a coordinate location of B in the current video frame P, coordinates of Br are (xr, yr), and coordinates of B are (x, y). A displacement between the current to-be-coded block and the reference block is referred to as a motion vector (MV), that is, MV=(xr−x, yr−y).

Considering that temporally or spatially adjacent blocks have strong correlation, an MV prediction technology may be used to further reduce bits needed for coding the MV. In H.265/HEVC, an inter prediction technology includes two MV prediction technologies: Merge and AMVP.

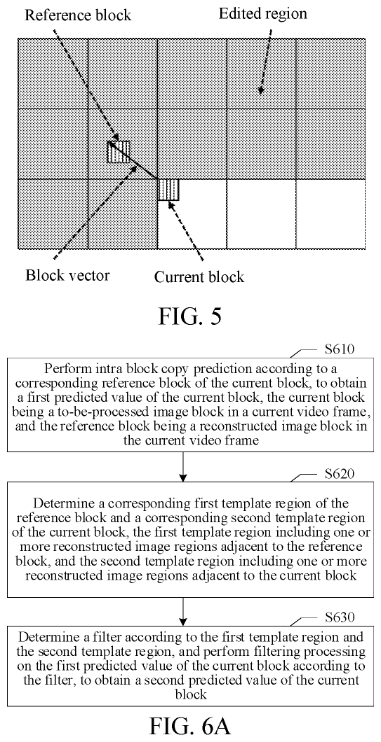

FIG. 5 is a schematic diagram of a principle of an intra block copy prediction mode according to an aspect of this disclosure. As shown in FIG. 5, an intra block copy (IBC) mode may be considered as a special inter prediction mode. An implementation principle of the intra block copy prediction mode is similar to a principle of a solution of performing motion compensation in the inter prediction mode. A difference is that, in the inter prediction, a reference block used for motion compensation is selected from a reference frame different from a current video frame, but in the intra block copy prediction mode, a reference block used for motion compensation is selected within the current video frame. In the intra block copy prediction mode, a block vector indicates a relative displacement of moving from a location of a current block to a location of a reference block in a current video frame.

Intra block copy is an intra coding tool used in HEVC screen content coding (SCC) extension, and significantly improves efficiency of screen content coding. In AVS3, VVC, and AV1, an IBC technology is also used to improve the performance of screen content coding. IBC is based on correlation of a screen content video in space, and a pixel of a current to-be-coded block is predicted based on a pixel of a coded image of a current image, so that bits required for coding pixels can be effectively reduced.

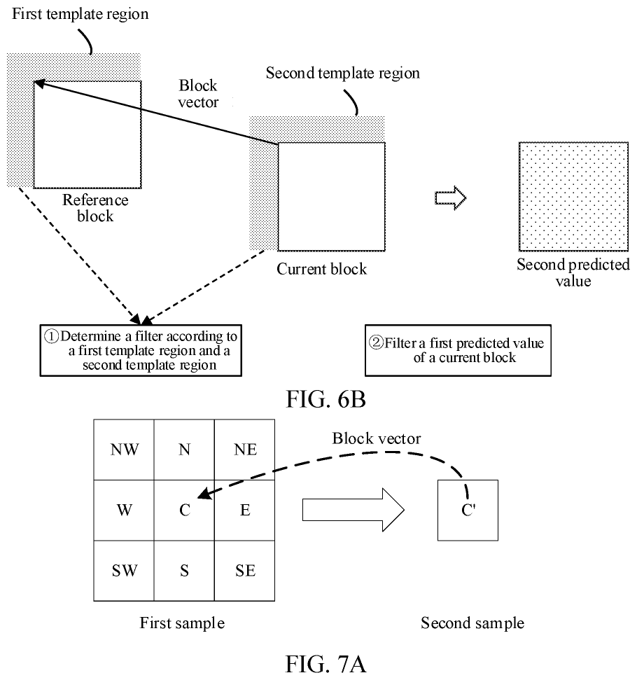

FIG. 6A is a flowchart of a video processing method according to an aspect of this disclosure. The video processing method may be performed by a terminal device or a server that sends or receives coded video data. In an aspect of this disclosure, for example, the method is performed by a terminal device. The terminal device may be, for example, the video decoding apparatus 210 or the video coding apparatus 220 shown in FIG. 2.

As shown in FIG. 6A, the video processing method in an aspect of this disclosure includes the following operations S610 to S630.

At S610, intra block copy prediction is performed on a current block according to a reference block of the current block, to obtain a first predicted value of the current block. The current block is a to-be-processed image block in a current video frame, and the reference block is a reconstructed image block in the current video frame. In the aspects of this disclosure, a to-be-processed image block may be a to-be-coded image block or a to-be-decoded image block.

At S620, a first template region of the reference block and a second template region of the current block are determined. The first template region includes one or more reconstructed image regions adjacent to the reference block, and the second template region includes one or more reconstructed image regions adjacent to the current block.

At S630, a filter is determined according to the first template region and the second template region, and the filtering processing is performed on the first predicted value of the current block according to the filter, to obtain a second predicted value of the current block.

FIG. 6B is a schematic diagram of a video processing method according to an aspect of this disclosure. FIG. 6B is a schematic diagram of the method in FIG. 6A.

The image block in an aspect of this disclosure is a basic unit for coding or decoding processing, and may include, for example, a coding unit, a luminance coding unit, a chrominance coding unit, a coding block, a luminance coding block, a chrominance coding block, a prediction unit, a luminance prediction unit, a chrominance prediction unit, a luminance prediction block, and a chrominance prediction block.

The reference block in an aspect of this disclosure may be an image block determined after the current block is displaced according to a block vector in the intra block copy prediction mode. Based on this, the reconstructed value of the pixel in the reference block is equal to the predicted value of the pixel in the current block. Correspondingly, a reconstructed value of a pixel in the first template region is equal to a predicted value of a pixel in the second template region.

In the video processing method provided in the aspects of this disclosure, intra block copy prediction may be performed on a current block according to a reference block of the current block, to obtain a first predicted value of the current block, a filter may be determined according to the first template region corresponding to the reference block and the second template region corresponding to the current block, and filtering processing may be performed on the first predicted value of the current block according to the filter, to obtain a second predicted value of the current block. The filter performs filtering processing on the first predicted value of the current block, so that space domain discontinuity between a predicted block (the first predicted value) of the current block and surrounding pixels can be eliminated, thereby improving image coding and decoding quality. The video processing method may be applied to a video codec or a video compression product using the IBC technology.

In the aspects of this disclosure, the reference block of the current block may be located in a sub-pixel region. An image in a natural scene is usually analog and continuous, and motion of an object in the image is also continuous. Therefore, motion offset is not discontinuous motion of an integer quantity of pixels. To improve prediction accuracy, motion estimation with sub-pixel precision is introduced to a video compression and coding technology. The sub-pixel region can, or can only, be obtained from an integer-pixel region through interpolation calculation. Interpolation calculation of a sub-pixel may be performed within a search range of a reference frame image between the integer-pixel motion estimation and the sub-pixel motion estimation. Based on this, the reference block of the current block may be located in an integer-pixel region, or may be located in a sub-pixel region.

In the aspects of this disclosure, the method for performing filtering processing on the first predicted value of the current block according to the filter may further include: determining whether the current block satisfies a filtering condition, where the filtering condition is used for determining whether to perform filtering processing on the current block; and when the filtering condition is satisfied, performing filtering processing on the first predicted value of the current block according to the filter.

In the aspects of this disclosure, the filtering condition includes at least one of the following conditions: (1) a stream parameter related to the current block has a specified value; (2) an image feature of the current block (or the current block) satisfies a preset first feature condition; (3) an image feature of the reference block (or the reference block) satisfies a preset second feature condition; or (4) an image feature of the template region (or the template region) satisfies a preset third feature condition.

Implementations of the foregoing four conditions are respectively described below.

In some aspects of this disclosure, the filtering condition may include condition (1) in which a stream parameter related to the current block has a specified value.

For example, syntax elements related to video coding and decoding exist in a video stream in which the current block is located, and these syntax elements may be used as stream parameters to instruct operations related to video coding and decoding.

A stream syntax description method is similar to the C language. Syntax elements of streams are represented by bold characters. Each syntax element is described by using a name (a group of English letters separated by underscores, and all letters can be lowercase), syntax, and semantics. Values of syntax elements in a syntax table and a main text are represented by using normal fonts. In some cases, another variable value derived from a syntax element may be applied to the syntax table, and such a variable is named by using a mixture of lowercase letters and uppercase letters with no underscore in the syntax table or the main text. A variable starting with an uppercase letter is used for decoding current and related syntax structures, and may also be used for decoding a subsequent syntax structure. Variables starting with a lowercase letter are used in a section in which the variables are located. A relationship between a mnemonic symbol of a syntax element value and a mnemonic symbol of a variable value and corresponding values are described in the main text. In some cases, the mnemonic symbol and the corresponding value are used equivalently. The mnemonic symbols are represented by one or more groups of letters separated by underscores. Each group of letters starts with an uppercase letter or may include a plurality of uppercase letters. When a length of a bit string is an integer multiple of 4, a hexadecimal symbol may be used. A hexadecimal prefix is “0x”, for example, “0x1a” indicates a bit string “0001 1010”.

In some aspects of this disclosure, the stream parameter includes a filtering flag, and the filtering flag is used to indicate whether to perform filtering processing on the image block. The filtering flag may include one or more of the following flags: (1) a sequence header filtering flag, used to indicate whether to perform filtering processing on an image block in a video frame sequence; (2) an image header filtering flag, used to indicate whether to perform filtering processing on an image block in a video frame; (3) a slice header filtering flag, used to indicate whether to perform filtering processing on an image block in an image slice; and (4) a block-level filtering flag, used to indicate whether to perform filtering processing on the current block.

In some aspects of this disclosure, when the stream parameter includes the block-level filtering flag, the block-level filtering flag is decoded when a preset decoding condition is satisfied, and decoding of the block-level filtering flag is forbidden when the preset decoding condition is not satisfied.

For example, the decoding condition includes one or more of the following conditions: (1) A high-layer syntax element in the stream parameter indicates to perform filtering processing on an image block, where the high-layer syntax element includes at least one of a sequence header filtering flag, an image header filtering flag, and a slice header filtering flag. (2) An area of the current block falls within a preset value range. For example, the area of the current block is greater than 32. (3) Location coordinates of the current block fall within a preset coordinate range. For example, a location coordinate (a horizontal coordinate and/or a vertical coordinate) of the current block is greater than or equal to a threshold. (4) A region range occupied by a reference region of the current block in the current video frame satisfies a preset range limit, and the reference region includes one or more of the current block, a template region of the current block, and an extension region of the template region. (5) The reference region of the current block satisfies a reference range limit of intra block copy prediction.

In an example for condition (4), the current video frame is divided into a plurality of image regions, for example, into M*N image regions. A quantity of image regions occupied by samples of the reference region in the current video frame is K. In this case, the quantity K may be used as a region range occupied by the reference region in the current video frame. The preset range limit may be determined based on a block size of the current block.

For example, the preset range limit may be that a region range (that is, the quantity K) is less than or equal to a quantity threshold. The quantity threshold may be represented as W*H*TH, where W is a width of the current block, His a height of the current block, and TH is a preset ratio coefficient.

In some aspects of this disclosure, the preset coordinate range is a coordinate threshold. In an example, verifying the location coordinates of the current block fall within the preset coordinate range includes verifying whether the location coordinates of the current block are greater than or equal to a coordinate threshold. In some aspects, a method for determining the coordinate threshold includes at least one of the following methods:

In an example, the coordinate threshold is determined according to a preset fixed value. In another example, the coordinate threshold is determined according to a template size of the template region; where when the template region is an image region located above the current block, the template size is a height of the template region; and when the template region is an image region located on the left of the current block, the template size is a width of the template region.

In the aspects of this disclosure, when the current block does not include a chrominance component, for example, the current block is a luminance block including only a luminance component, the template size of the template region is used as the coordinate threshold.

When the current block includes a chrominance component, for example, when the current block is a chrominance block including only a chrominance component or an image block including both a luminance component and a chrominance component, a weighting coefficient is determined according to a sampling ratio of the luminance component to the chrominance component, and a product of the weighting coefficient and the template size of the template region is used as the coordinate threshold. For example, for an image in a YUV420 format, the length and the width of a luminance component are twice those of a chrominance component. In this case, the weighting coefficient may be determined as 2.

In an aspect, the stream includes a high-layer syntax element indicating whether to use an intra block copy adaptive prediction filter (IBC-APF) provided in an aspect of this disclosure, and it is determined whether to use an IBC-APF-based filtering method for the current block according to the high-layer syntax element.

The high-layer syntax element may include, for example, one or more of a sequence header syntax element (seq_ibc_apf_flag), an image header syntax element (pic ibc_apf_flag), and a slice header syntax element (slice_ibc_apf_flag). A decoding priority is: sequence header syntax element>image header syntax element>slice header syntax element>block-level syntax element. If a syntax element with a high priority indicates that the IBC-APF cannot be used, a syntax element with a low priority does not need to be decoded.

A video sequence is a highest-layer syntax structure of a stream. A video sequence starts from a first sequence header, and a sequence end code or a video editing code indicates the end of a video sequence. A sequence header from the first sequence header of the video sequence to the sequence end code or the video editing code that appears for the first time is a repeated sequence header. Each sequence header is followed by one or more coded images, and each image is preceded by an image header. The coded images are arranged in the stream according to a stream order, and the stream order is the same as the decoding order. The decoding order may be different from a display order.

An image may be a frame or a picture, and coded data of the image starts from an image start code and ends with a sequence start code, a sequence end code, or a next image start code. In the stream, coded data of two fields of interlaced images may appear sequentially, or may appear in a mixed manner. A decoding order and a display order of the two fields of data are specified in the image header. The image type includes: an I image, a P image, and a B image.

A slice is a rectangular region in an image and includes a part of several maximum coding units in the image, and slices do not overlap with each other.

In another aspect, the stream includes a high-layer syntax element, to indicate whether to use any intra block copy prediction filter (IBC-PF). The IBC-PF filter may include a plurality of different filtering manners.

In another aspect, the stream includes a block-level filtering flag of cu_ibc_apf_flag, to indicate whether to perform filtering processing on the current block in an IBC-APF mode.

In an aspect of this disclosure, the stream parameter may further include a filtering index. The filtering index is used to indicate a filtering mode of filtering processing to be performed on the image block, and the filtering mode includes one or more different filtering methods.

For example, the stream includes a block-level flag of cu_ibc_pf_flag, to indicate whether to perform filtering processing on the current block in an IBC-PF mode. If cu_ibc_pf_flag indicates that filtering processing may be performed on the current block in the IBC-PF mode, the stream includes a block-level index of cu_ibc_pf_index, to indicate the IBC-PF method used for the current block. Decoding of cu_ibc_pf_index depends on cu_ibc_pf flag.

Table 1 shows a syntax structure of the stream parameter related to an IBC-PF filter in an application scenario according to an aspect of this disclosure.

TABLE 1
A syntax structure of the stream parameter
related to an IBC-PF filter

| | |
|---|---|
| cu_ibc_pf_flag | ae (v) |
| if (CuIbcPfFlag) { | |
| cu_ibc_pf _index | ae (v) |
| } | |

The block-level intra block copy prediction filtering flag of cu_ibc_pf_flag is a binary variable. A value ‘1’ indicates that the IBC-PF mode may be used. A value ‘0’ indicates that the IBC-PF mode is not used. A value of CulbcPfFlag is equal to a value of cu_ibc_pf_flag. If the stream does not include cu_ibc_pf_flag, the value of CulbcPfFlag is 0.

The block-level intra block copy prediction filtering index of cu_ibc_pf_index indicates a used IBC-PF mode. A value of CulbcPfIndex is equal to a value of cu_ibc_pf index. If the stream does not include cu_ibc_pf_index, the value of CulbcPfIndex is 0.

Using three filtering methods as an example, Table 2 shows values and corresponding semantics of the stream parameters.

TABLE 2
Examples of values and corresponding
semantics of the stream parameters

| cu_ibc_{—} | cu_ibc_{—} | |
|---|---|---|
| pf_flag | pf_index | Semantics |
| 0 | x | An IBC-PF mode is not used |
| 1 | 0 | An IBC-PF mode 1 is used |
| 1 | 1 | An IBC-PF mode 2 is used |
| 1 | 2 | An IBC-PF mode 3 (an IBC-APF mode) is used |

When a value of cu_ibc_pf_flag is 0, it indicates that filtering processing is not performed on the current block by using the IBC-PF mode. Therefore, cu_ibc_pf_index does not need to be decoded. Alternatively, cu_ibc_pf_index of the current block may not be signaled.

When a value of cu_ibc_pf_flag is 1, it indicates that filtering processing is performed on the current block by using the IBC-PF mode. In this case, cu_ibc_pf_index may be then decoded, to determine a filtering mode used for the current block. The IBC-PF mode 3 indicates an intra block copy adaptive prediction filtering mode IBC-APF provided in an aspect of this disclosure, and the IBC-PF mode 1 and the IBC-PF mode 2 are filtering methods other than the IBC-APF filtering mode provided in an aspect of this disclosure, for example, mean filtering, median filtering, and Gaussian filtering.

In some aspects of this disclosure, in addition to indicating performing filtering processing on the image block, the filtering flag is further used to indicate a filtering mode of filtering processing to be performed on the image block. The filtering mode includes one or more different filtering methods. Using the block-level stream parameter as an example, a filtering flag of cu_ibc_pf_flag, or in some examples only the filtering flag, may be used to indicate an IBC mode used for the current block.

Table 3 shows values and semantics when the filtering flag of cu_ibc_pf_flag is used according to an aspect of this disclosure.

TABLE 3
Examples of values and semantics for a filtering
flag of cu_ibc_pf_flag

| cu_ibc_pf_flag | Semantics |
|---|---|
| 0 | An IBC-PF mode is not used |
| 1 | An IBC-PF mode 1 is used |
| 2 | An IBC-PF mode 2 is used |
| 3 | An IBC-PF mode 3 (an IBC-APF mode) is used |

As shown in Table 3, when cu_ibc_pf_flag of the current block is equal to 3, it indicates that filtering processing is performed on the current block by using the IBC-APF mode.

In some aspects of this disclosure, the stream parameter further includes a filtering type field used to indicate a filtering type.

When a value of the filtering type field is a first value, the filtering flag is used to indicate whether to perform filtering processing on the image block and indicate that a filtering mode of filtering processing to be performed on the image block is a preset first mode.

When a value of the filtering type field is a second value, the filtering flag is used to indicate whether to perform filtering processing on the image block and indicate that a filtering mode of filtering processing to be performed on the image block is a preset second mode, where the second mode is a filtering mode different from the first mode.

For example, the stream includes a type field ibc_type (which may be a sequence-level, image-level, slice-level, or block-level flag) that indicates an IBC type. When ibc_type has different values, it indicates that different filtering manners are used.

Table 4 shows values and semantics of a filtering type field and a filtering flag in an application scenario according to an aspect of this disclosure.

TABLE 4
Values and semantics corresponding to a
filter type field and a filtering flag

| | cu_ibc_{—} | |
|---|---|---|
| ibc_type | pf_flag | Semantics |
| 0 | 0 | An IBC-PF mode is not used |
| 0 | 1 | An IBC-PF mode 1 is used |
| 0 | 2 | An IBC-PF mode 2 is used |
| 1 | 0 | An IBC-PF mode is not used |
| 1 | 1 | An IBC-PF mode 3 (an IBC-APF mode) is used |

In some aspects of this disclosure, a binarization/de-binarization method for the filtering flag of cu_ibc_pf_flag and/or the filtering index of cu_ibc_pf_index may use a variable-length code or a fixed-length code. The variable-length code includes a truncated unary code, a truncated binary code, a Kth-order exponential Golomb code, or the like.

In some aspects of this disclosure, a value of a filtering flag may be determined according to a coding loss, and the coding loss is calculated by using a preset cost function.

A first value is assigned to the filtering flag if a coding loss after filtering processing is performed on the template region of the image block is less than a coding loss before filtering processing is performed on the template region of the image block, where the first value is used to indicate to perform filtering processing on the image block.

A second value is assigned to the filtering flag if the coding loss after filtering processing is performed on the template region of the image block is greater than the coding loss before filtering processing is performed on the template region of the image block, where the second value is used to indicate to forbid filtering processing on the image block.

For example, in an aspect of this disclosure, a sum of absolute difference (SAD) may be used as a cost function to calculate the coding loss of the current block before and after filtering. If coding loss of performing filtering processing by using the IBC-PF and the IBC-APF is smaller, it is determined that the IBC-PF and the IBC-APF modes are used for the current block. Otherwise, it is forbidden to use the IBC-PF and IBC-APF modes for the current block.

In some aspects of this disclosure, a value of the filtering flag is determined according to a quantity of transform coefficients in the image block.

A first value is assigned to the filtering flag if the transform coefficient in the image block satisfies a preset first quantity condition, where the first value is used to indicate to perform filtering processing on the image block.

A second value is assigned to the filtering flag if the transform coefficient in the image block satisfies a preset second quantity condition, where the second value is used to indicate to forbid filtering processing on the image block.

For example, in an aspect of this disclosure, a quantity of transform coefficients that are in the current block and whose coefficient values are even numbers may be counted, and then it is determined whether to use the IBC-PF and the IBC-APF according to whether the quantity of coefficients is an odd or even number. For example, a quantity of transform coefficients that are in a previous block and whose coefficient values are even numbers is m, the first quantity condition may be that m is an odd number, and the second quantity condition may be that m is an even number.

In some aspects, a parameter value of the filtering flag may also be derived by using another implicit coefficient.

In some aspects of this disclosure, the filtering condition to perform the filtering processing on the current block may include the condition (2): an image feature of the current block satisfies a preset first feature condition.

For example, the first feature condition includes one or more of the following conditions:

In condition (2.1), the current video frame in which the current block is located has a specified image type.

If the current video frame does not have a specified image type, it is determined that the IBC-APF cannot be used for the current video frame, and it is unnecessary to decode an image header of the current video frame and a syntax element at a level below an image level to determine a syntax element related to the IBC-APF. For example, if the IBC-APF mode can be used, or only used, for an I-type image, syntax elements related to the IBC-APF at a block level and in a slice header and an image header do not need to be decoded for a non-I-type image.

In condition (2.2), the current block has a specified distribution location in the current video frame.

For example, the IBC-APF mode may be used, or only used, when a horizontal coordinate and a vertical coordinate of the current block are greater than a size of the filter template, to avoid, for example, that a sample out of boundary of an independently decodable image is used for filtering. The “independently decodable image” is, for example, a maximum coding unit or a slice.

In condition (2.3), an image size of the current block falls within a preset size range, where the image size includes one or more of a width, a height, or an area.

The IBC-APF can be used, or only used, when an image size (a block size) of the current block satisfies a preset condition. If the image size of the current block does not satisfy the condition, the block-level syntax element of the current block related to the IBC-APF does not need to be decoded. The image size may include one or more of a width, a height, or an area of the current block. For example, the preset condition is that the image size of the current block is greater than, greater than or equal to, less than, or less than or equal to a threshold. There may be a plurality of conditions related to the image size of the current block, and each condition corresponds to a different threshold. For example, the IBC-PF and the IBC-APF are used, or only used, when the image size of the current block satisfies all the following conditions: the area (width*height) of the current block is greater than 64, the width of the current block is less than or equal to 64, and the height of the current block is less than or equal to 64.

For another example, filtering processing can be performed on the current block when, or only when, the width*height of the current block is greater than 32.

In condition (2.4), a block vector resolution of the current block falls within a preset resolution range.

If a block vector resolution of the current block is one of adaptive block vector resolutions (ABVR), the IBC-APF can be used when, or only, when the block vector resolution of the current block satisfies a specified condition. If the block vector resolution of the current block does not satisfy the specified condition, the block-level syntax element of the current block related to the IBC-APF does not need to be decoded. The specified condition may be: the block vector resolution of the current block falls within a preset resolution range. For example, the block vector resolution of the current block is a specified subset of an available ABVR list.

For example, the ABVR currently allows {1-pel, 4 pel}, and the IBC-APF is used, or only used, when the block vector resolution of the current block is 1-pel.

For example, the ABVR currently allows {1-pel, 4 pel}, and the IBC-APF is used, or only used, when the block vector resolution of the current block is 4-pel.

For example, the ABVR currently allows {¼ pel, 1-pel, 4 pel}, and the IBC-APF is used, or only used, when the block vector resolution of the current block is 1-pel.

For example, the ABVR currently allows {¼ pel, 1-pel, 4 pel}, and the IBC-APF is used, or only used, when the block vector resolution of the current block is 1-pel or 4-pel.

In condition (2.5), a block vector residual of the current block falls within a preset residual range, where the block vector residual includes one or more of a horizontal block vector residual or a vertical block vector residual. Block vector residual (BVD)=BV (block vector)−BVP (predicted block vector), and absolute residual may also be used herein, that is, BVD=ABS (BV-BVP).

The IBC-APF can be used, or only used, when a block vector residual (BVD) of the current block satisfies a condition. If the block vector residual of the current block does not satisfy the condition, the block-level syntax element of the current block related to the IBC-APF does not need to be decoded. For example, the condition is: an absolute value of a horizontal BVD or (and) a vertical BVD of the current block is less than (which may also be equal to, less than or equal to, greater than or equal to, or greater than) a specified threshold.

For example, the IBC-PF and the IBC-APF can be used, or only used, when a horizontal BVD and a vertical BVD of the current block are both equal to 0.

In condition (2.6), a block vector index of the current block falls within a preset index range.

The block vector index is a “predicted block vector index”. When exporting a block vector, the decoding end needs to first decode the predicted block vector BVP and the block vector residual BVD, to obtain a block vector BV=BVP+BVD. A predicted block vector used is indicated by a predicted block vector index.

The IBC-APF can be used, or only used, when a block vector index of the current block satisfies a condition. If the block vector index of the current block does not satisfy the condition, the block-level syntax element of the current block related to the IBC-APF does not need to be decoded. The condition is: a block vector index of the current block falls within a preset index range. For example, an absolute value of the block vector index bvp_idx of the current block may be less than (which may also be equal to, less than or equal to, greater than or equal to, or greater than) a specified threshold.

In condition (2.7), the current block is an image block having a specified color component.

The IBC-APF can be used, or only used, when the current block is a specified color component. For example, the IBC-PF and the IBC-APF are used, or only used, for a luminance component Y, or the IBC-PF and the IBC-APF are used, or only used, for a chrominance component U or V, or both are allowed.

In some aspects of this disclosure, the filtering condition to perform the filtering processing on the current block may include the condition (3): an image feature of the reference block satisfies a preset second feature condition.

For example, the second feature condition includes an example as follows:

In the example, a sample of the reference block satisfies a preset sample available condition, where the sample available condition includes that the sample is located within boundary of an independently decodable image or decoding and reconstruction of the sample have been completed. The “independently decodable image” is, for example, a maximum coding unit. The sample available condition herein may mean that the sample does not exceed boundary of a maximum coding unit (or a slice or an image).

A location of the sample of the reference block may be determined according to a block vector of the predicted block. The IBC-APF can be used, or only used, when the block vector of the current predicted block satisfies a validity condition. A condition for determining whether the reference block and the template region can be used includes: a sample is located within boundary of an independently decodable image, or decoding and reconstruction of the sample have been completed. The condition may further include other limits, for example, satisfying a hardware implementation limitation.

In some aspects of this disclosure, the filtering condition to perform the filtering processing on the current block may include the condition (4): an image feature of the template region satisfies a preset third feature condition.

For example, the third feature condition may include one or more of the following conditions:

In condition (4.1), an area of the template region falls within a preset area range.

In condition (4.2), a sample of the template region satisfies a preset sample available condition, where the sample available condition includes that the sample is located within boundary of an independently decodable image or decoding and reconstruction of the sample have been completed.

In condition (4.3), a quantity of sample pairs collected in the template region is greater than a quantity of model parameters of the filter.

Because the model parameter of the filter is solved by using the least square method, a quantity of sample pairs needs to be greater than a quantity of model parameters to be solved.

The foregoing aspects provide a plurality of filtering conditions for determining whether to perform filtering processing on the current block. In this embodiment of this disclosure, one or more of the foregoing filtering conditions may be used. Different filtering methods may correspond to different filtering conditions. This is not limited in aspects of this disclosure.

In some aspects of this disclosure, a method for determining a filter according to the first template region and the second template region may include: selecting a first sample from the first template region, and selecting a second sample corresponding to the first sample from the second template region; and determining a filter based on a sample pair formed by the first sample and the second sample, where an input item of the filter includes a pixel value of the first sample, an output item of the filter includes a pixel value of the second sample, and the pixel value includes a predicted value or a reconstructed value. For example, after the first sample and the second sample are selected, a first pixel value of the first sample is used as an input item of the filter, and a second pixel value of the second sample is used as an output item of the filter. The parameter of the filter is determined according to the first pixel value of the first sample and the second pixel value of the second sample.

In some aspects of this disclosure, the input item of the filter further includes a pixel value of one or more adjacent pixels, and the adjacent pixel is a pixel nearest to or next nearest to the first sample.

For example, the filter model may be represented as follows in equation (1)

$$y = p 0 ⋆ x 0 + p 1 ⋆ x 1 + p 2 ⋆ x 2 + … + pn ⋆ xn \qquad Eq . ( 1 )$$

where {p0, p1, . . . , pn} are filter parameters, {x0, x1, . . . , xn} are input values, and y is an output value. xi is derived based on a reference sample and an adjacent sample corresponding to the current to-be-filtered sample.

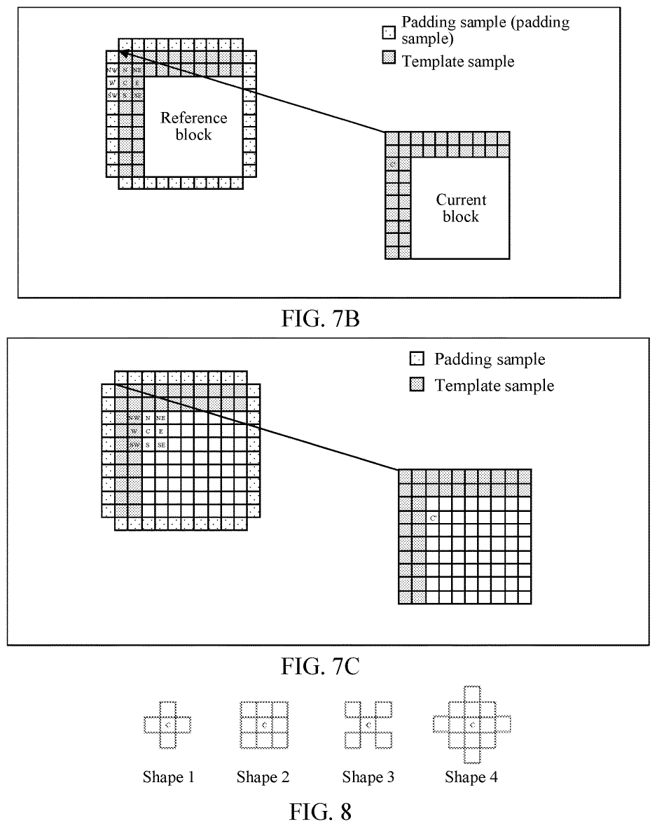

FIG. 7A is a schematic diagram of a corresponding form of samples related to a filter according to aspects of this disclosure. As shown in FIG. 7A, a first sample C is selected from a first template region in which the reference block is located, and a second sample C′ is selected from a second template region in which the current block is located.

A location of the first sample C is the center of the filter, and is determined after a location of the second sample C′ is displaced based on a block vector.

The adjacent pixels of the first sample C may include a plurality of nearest pixels, for example, a plurality of pixels N, S, W, and E located above and below and on the left and the right of the first sample C shown in FIG. 7A.

The adjacent pixels of the first sample C may include a plurality of next nearest pixels, for example, a plurality of pixels NW, NE, SW, and SE located on the upper left, upper right, lower left, and lower right of the first sample C shown in FIG. 7A.

Each time such a correspondence is established between the first sample C and the second sample C′, a sample pair may be formed, that is, a correspondence equation may be generated. A plurality of such correspondence equations may be used to solve weighting parameters of the filter model.

The first sample C and the second sample C′ are placed in the current frame, as shown in FIG. 7B. FIG. 7B is a schematic diagram of determining a filter parameter according to an aspect of this disclosure.

In the aspects of this disclosure, the shape of the filter may be of a plurality of different types. FIG. 8 is a schematic diagram of a shape of a filter used in some application scenarios according to an aspect of this disclosure.

As shown in FIG. 8, a shape 1 indicates that input items of a first type of filter include: a first sample C and four nearest pixels located above and below and on the left and right of the first sample C.

A shape 2 indicates that input items of a second type of filter include: a first sample C, four nearest pixels located above and below and on the left and right of the first sample C, and four next nearest pixels located on the upper left, upper right, lower left, and lower right of the first sample C.

A shape 3 indicates that input items of a third type of filter include: a first sample C and four next nearest pixels located on the upper left, upper right, lower left, and lower right of the first sample C.

A shape 4 indicates that input items of a fourth type of filter include: a first sample C, four nearest pixels located above and below and on the left and right of the first sample C, four next nearest pixels located on the upper left, upper right, lower left, and lower right of the first sample C, and four next nearest pixels located above and below and on the left and right of the first sample C (that is, outer pixels adjacent to the nearest pixels in corresponding orientations).

In the aspects of this disclosure, pixel boundary of the template region may be padded according to the shape of the filter. For example, for the second type of filter in the shape 2 shown in FIG. 8, pixels need to be padded by one unit at an edge of the template region. For another example, for the fourth type of filter in the shape 4 shown in FIG. 8, pixels need to be padded by two units at an edge of the template region. Referring to FIG. 7B, a sample in the padded region is a padding sample. When determining the filter, the padding sample may also be used.

In some aspects of this disclosure, the filter includes one or more combination items having independent weighting parameters, and the combination item uses pixel values of one or more pixels as input items.

The filter in an aspect of this disclosure may include at least one monomial, and each monomial may have an independent weighting parameter. When one monomial includes pixel values of at least two pixels as input items, the monomial is referred to as a combination item.

In some aspects of this disclosure, the filter includes at least two combination items with different orders, and the order is a highest power of an input item in the combination item. A nonlinear factor may be introduced through an exponentiation operation, to improve a fitting effect of the filter for sample correspondence.

Assuming that Rj represents an input of the filter, xi may be any combination of Rj, such as at least one of Rj, m*Rj, Rj^{k}, and a constant bias term B, or may be a combination term of multiplication and addition of any of these terms. Herein, m and k are non-zero integers, and k is an integer greater than 1.

In some aspects of this disclosure, the filter may include one or more candidate models according to equations (2)-(13).

$$y = {p}_{0} C + {p}_{1} N + {p}_{2} S + {p}_{3} W + {p}_{4} E + {p}_{5} {C}^{2} + {p}_{6} B . \qquad Eq . ( 2 )$$

$$y = {p}_{0} C + {p}_{1} N + {p}_{2} S + {p}_{3} W + {p}_{4} E + {p}_{5} B . \qquad Eq . ( 3 )$$

$$y = {p}_{0} C + {p}_{1} B . \qquad Eq . ( 4 )$$

$$y = {p}_{0} C + {p}_{1} ( \frac{N + S}{2} ) + {p}_{2} ( \frac{W + E}{2} ) + {{p}_{3} ( \frac{N + S}{2} )}^{2} + {{p}_{4} ( \frac{W + E}{2} )}^{2} + {p}_{5} {C}^{2} + {p}_{6} B . \qquad Eq . ( 5 )$$

$$y = {p}_{0} C + {p}_{1} ( \frac{N + S}{2} ) + {p}_{2} ( \frac{W + E}{2} ) + {{p}_{2} ( \frac{N + S}{2} )}^{2} + {{p}_{4} ( \frac{W + E}{2} )}^{2} + {p}_{5} ( \frac{N + S}{2} ) ( \frac{W + E}{2} ) + {p}_{6} B . \qquad Eq . ( 6 )$$

$$y = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} {C}^{2} + {p}_{6} B . \qquad Eq . ( 7 )$$

$$y = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} ( \frac{N + S}{2} ) ( \frac{W + E}{2} ) + {p}_{6} B . \qquad Eq . ( 8 )$$

$$y = {p}_{0} C + {p}_{1} ( \frac{N + S}{2} ) + {p}_{2} ( \frac{W + E}{2} ) + {p}_{3} ( \frac{N W + S E}{2} ) + {p}_{4} ( \frac{N E + S W}{2} ) + {p}_{5} B . \qquad Eq . ( 9 )$$

$$y = {p}_{0} ( \frac{N + S + W + E}{4} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + W + E}{4} )}^{2} + {p}_{6} B . \qquad Eq . ( 10 )$$

$$y = {p}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + 4 C + W + E}{8} )}^{2} + {p}_{6} B . \qquad Eq . ( 11 )$$

$$y = {p}_{0} C + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {p}_{5} {C}^{2} + {p}_{6} B . \qquad Eq . ( 12 )$$

$$y = {p}_{0} C + {p}_{1} S + {p}_{2} W + {p}_{3} E + {p}_{4} SW + {p}_{5} SE + {p}_{6} {C}^{2} + {p}_{7} B . \qquad Eq . ( 13 )$$

In some aspects of this disclosure, the samples used for determining the filter may be all pixels or some pixels selected from the first template region and the second template region. When some pixels are selected to determine the filter, pixels may be sampled in a corresponding template region according to a preset sampling rule.

In some aspects of this disclosure, a method for selecting a sample from the template region may further include: obtaining a pixel sampling mode of the current block, where the pixel sampling mode includes full pixel sampling or partial pixel sampling; selecting a pixel from all pixels in the template region as a sample when the pixel sampling mode of the current block is full pixel sampling; and selecting some pixels in a specified sampling location in the template region as samples when the pixel sampling mode of the current block is partial pixel sampling. A pixel is selected from all pixels in the first template region as the first sample, and a pixel is selected from all pixels in the second template region as the second sample when the pixel sampling mode of the current block is full pixel sampling; and a pixel is selected from some pixels in a first specified sampling location in the first template region as the first sample, and a pixel is selected from some pixels in a second specified sampling location in the second template region as the second sample when the pixel sampling mode of the current block is partial pixel sampling.

In some aspects of this disclosure, the specified sampling location includes at least one of the following three types of sampling locations.

In an example of first sampling location, a specified sampling location whose pixel location coordinates satisfy a preset coordinate value condition.

In some aspects of this disclosure, the coordinate value condition includes: at least one of a horizontal location coordinate or a vertical location coordinate of a pixel is an even number; or at least one of a horizontal location coordinate or a vertical location coordinate of a pixel is an odd number.

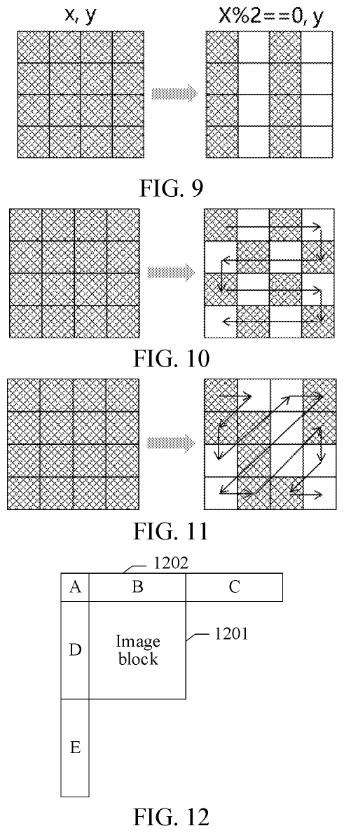

FIG. 9 is a schematic diagram of selecting a sampling location based on location coordinates of a pixel according to an aspect of this disclosure.

As shown in FIG. 9, a coordinate system is established by using an upper left corner as a coordinate origin (0, 0) in the template region, a horizontal location coordinate x represents a sequential location of a pixel arranged from left to right in the horizontal direction, and a vertical location coordinate y represents a sequential location of a pixel arranged from top to bottom in the vertical direction.

According to a preset coordinate value condition, an even location, an odd location, or all locations may be selected as the specified sampling location in the horizontal direction, or an even location, an odd location, or all locations may be selected as the specified sampling location in the vertical direction.

For example, in the aspect shown in FIG. 9, pixel locations that are even locations in the horizontal direction and all locations in the vertical direction are selected as specified sampling locations. That is, pixel locations of a shadow part in the figure are selected as the specified sampling locations.

In an example of a second sampling location, a specified sampling location selected along a preset pixel scanning direction.

In some aspects of this disclosure, pixels in the template region may be scanned in any scanning manner such as round-trip scanning or ZigZag scanning, so as to sequentially select specified sampling locations along a preset pixel scanning direction based on a preset sampling rule. The preset sampling rule may be, for example, interval sampling, that is, selecting a specified sampling location at interval of one or more scanning pixels.

FIG. 10 is a schematic diagram of selecting a sampling location based on a round-trip scanning manner according to some aspects of this disclosure.

As shown in FIG. 10, a row of pixels in the template region is scanned from left to right, and after boundary is reached, a next row of pixels is scanned from right to left. In a pixel scanning process, along the scanning direction, a specified sampling location is selected at interval of one scanning pixel. For example, an arrow shown in the figure indicates a scanning direction, and a pixel location of a shadow part is a selected specified sampling location.

FIG. 11 is a schematic diagram of selecting a sampling location based on a ZigZag scanning manner according to an aspect of this disclosure.

As shown in FIG. 11, pixels are scanned from an upper left corner to a lower right corner in a ZigZag scanning manner in the template region. In a pixel scanning process, along the scanning direction, a specified sampling location is selected at interval of one scanning pixel. For example, an arrow shown in the figure indicates a scanning direction, and a pixel location of a shadow part is a selected specified sampling location.

In an example of third sampling location, a specified sampling location whose pixel value falls within a preset value range.

For example, for a pixel on which decoding and reconstruction have been completed in the template region, when, or in some examples only when, a reconstructed value of the pixel is greater than/less than a threshold, the pixel is used for filter fitting.

For example, one filter may be obtained through fitting by using a pixel whose reconstructed value is greater than a preset threshold in the template region, and another filter may be obtained through fitting by using a pixel whose reconstructed value is less than or equal to the preset threshold in the template region. When performing filtering processing on the first predicted value of the pixel in the current block, different filters may be correspondingly selected for filtering processing according to a value relationship between the first predicted value and the preset threshold.

In some aspects of this disclosure, the template region is formed by combining one or more nearest regions or next nearest regions. The nearest region includes an image region that is located above or on the left of the image block and that has a specified image size, and the next nearest region includes an image region that is located on the upper left, lower left, or upper right of the image block and that has a specified image size.

FIG. 12 is a schematic diagram of distribution of a template region corresponding to an image block according to some aspects of this disclosure.

As shown in FIG. 12, a template region corresponding to an image block 1201 may be formed by a plurality of sub-regions 1202, where each sub-region 1202 may be a nearest region or a next nearest region of the image block. The nearest region, for example, may include an image region B located above the image block 1201 or an image region D located on the left of the image block 1201. The next nearest region, for example, may include an image region A located on the upper left of the image block 1201, an image region E located on the lower left of the image block 1201, or an image region C located on the upper right of the image block 1201.

One or more of the image regions A to E may be combined to form a template region of the image block 1201.

In some aspects of this disclosure, image sizes of sub-regions used to form the template region are specified as follows:

The nearest region B above the image block 1201 has the same image size as the image block 1201 in a horizontal direction, and the nearest region B above the image block 1201 has a specified image size in a vertical direction.

The nearest region D on the left of the image block 1201 has the same image size as the image block 1201 in a vertical direction, and the nearest region D on the left of the image block 1201 has a specified image size in a horizontal direction.

The next nearest region C on the upper right of the image block 1201 has the same image size as the image block 1201 in a horizontal direction, and the next nearest region C on the upper right of the image block 1201 has a specified image size in a vertical direction.

The next nearest region E on the lower left of the image block 1201 has the same image size as the image block 1201 in a vertical direction, and the next nearest region E on the lower left of the image block 1201 has a specified image size in a horizontal direction.

The next nearest region A on the upper left of the image block 1201 has the specified image size in both a horizontal direction and a vertical direction.

The specified image size may be a preset value greater than or equal to one. For example, the specified image size may be set to 6. When the specified image size is greater than one, filtering processing may be performed by using a plurality of layers of adjacent pixels, thereby improving continuity between pixels in the current block and adjacent pixels.

In some aspects of this disclosure, sub-regions forming the template region of the image block may have the same specified image size or different specified image sizes. For example, the size of the image region C in the vertical direction may be the same as or different from the size of the image region E in the horizontal direction.

In some aspects of this disclosure, template sizes of corresponding template regions may also be different for image blocks having different color components. For example, a template size of a template region of a luminance block is different from a template size of a template region of a chrominance block.

In some aspects of this disclosure, pixels on which decoding and reconstruction have been completed or that can be used may be selected from the sub-region as samples for filter fitting of the current block. For example, when decoding and reconstruction have been completed on some pixels in the image region C, and decoding and reconstruction have not been completed on other pixels, the pixels on which decoding and reconstruction have been completed may be selected from the image region C as samples for filter fitting of the current block.

In some aspects of this disclosure, when a pixel on which decoding and reconstruction have been completed in the sub-region does not satisfy a specified size, this next nearest region may be configured as unavailable. For example, when the lower right corner of the image region C is not reconstructed or exceeds image boundary, the image region C may be configured as unavailable. For another example, when the lower right corner of the image region E is not reconstructed or exceeds image boundary, the image region E may be configured as unavailable.

In some aspects of this disclosure, all sub-regions shown in FIG. 12 may be combined to form the template region, or some sub-regions may be combined to form the template region.

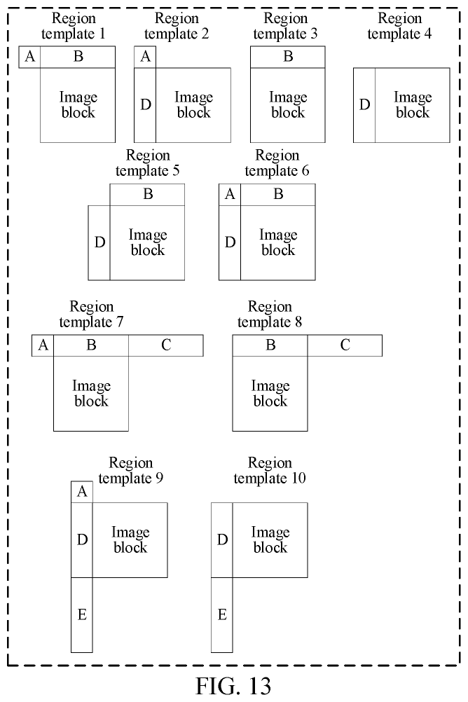

FIG. 13 is a schematic diagram of types of forming different template regions with both some sub-regions and image blocks according to some aspects of this disclosure. As shown in FIG. 13, ten exemplary types of template regions may be formed based on a combination of different sub-regions. In this disclosure of this disclosure, one or more candidate template regions may be designated for an image block.

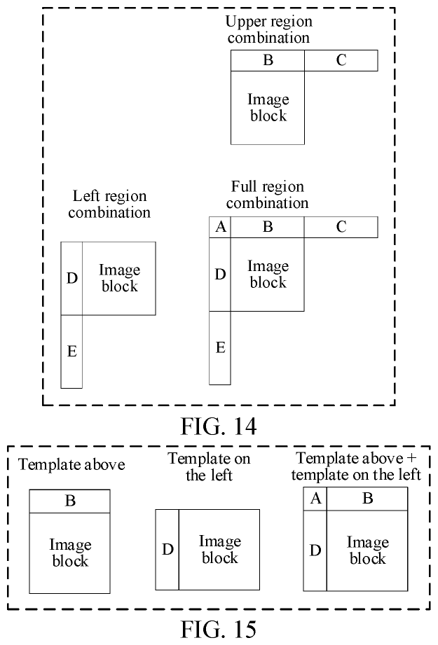

FIG. 14 is a schematic diagram of a template region selected for an image block according to some aspects of this disclosure. As shown in FIG. 14, in an aspect of this disclosure, the template region corresponding to the image block includes at least one of a full region combination, a left region combination, or an upper region combination.

The full region combination includes the nearest regions located on the left and above the image block and the next nearest regions located on the upper left, the lower left, and the upper right of the image block.

The left region combination includes the nearest region located on the left of the image block and the next nearest region located on the lower left of the image block.

The upper region combination includes the nearest region located above the image block and the next nearest region located on the upper right of the image block.

In some aspects of this disclosure, a region type of the template region used by the image block may be identified by using a region type field in the video stream. For example, when a value of the region type field is 1, it indicates that a template region selected for the image block is a full region combination shown in FIG. 10. When a value of the region type field is 01, it indicates that a template region selected for the image block is a left region combination shown in FIG. 10. When a value of the region type field is 00, it indicates that a template region selected for the image block is an upper region combination shown in FIG. 10.

In some aspects of this disclosure, after the template region used for filter fitting of the image block is determined, availability information of one or more sub-regions forming a reference region may be obtained, and then a region range of the template region is adjusted according to the availability information of the one or more sub-regions.

In some aspects of this disclosure, the adjusting a region range of the template region according to the availability information of the one or more sub-regions may further include: removing a sub-region in an unavailable state from the template region; and configuring the template region to be in the unavailable state when all sub-regions in the template region are in the unavailable state.

For example, a value of an indication field corresponding to an image block is obtained as 1 by parsing the video stream, it indicates that a template region used for color component prediction on the image block is a full region combination including five sub-regions A to E shown in FIG. 10.

When performing filtering processing on the image block, availability information of each sub-region in the template region may be obtained, and the region range of the template region may be adjusted according to the availability information.

For example, the sub-regions A, B, and C are image regions located above the image block. If coding reconstruction has not been completed on the sub-regions A, B, and C, the sub-regions A, B, and C are in the unavailable state. In this case, the area range of the template region may be adjusted from A+B+C+D+E to D+E.

For another example, the sub-regions D and E are image regions located on the left of the image block. If coding reconstruction has not been completed on the sub-regions D and E either, the sub-regions D and E are also in the unavailable state. In this case, the five sub-regions A to E are all in the unavailable state, and therefore the template region based on the full region combination may be entirely configured to be in the unavailable state.

In some aspects of this disclosure, a plurality of different filters may be used to perform filtering processing on the current block, and then a weighting operation is performed on filtering processing results of the plurality of filters, to obtain a final predicted value of the current block. In all the embodiments of this disclosure, a final predicted image may be obtained by performing a weighting operation on the first predicted value obtained through intra block copy prediction and the second predicted value obtained by performing filtering processing on the first predicted value.

In some aspects of this disclosure, after the second predicted value of the current block is obtained, a weighting operation is performed on the first predicted value and the second predicted value according to a preset weighting coefficient, to obtain a third predicted value of the current block.

For example, in an aspect of this disclosure, the third predicted value pred of the current block may be determined according to equation (14) as follows:

pred=w*pred₁+(1−w)*pred₂ Eq. (14)

where pred₁ represents a first predicted value obtained through intra block copy prediction, pred₂ represents a second predicted value obtained after prediction processing is performed on the first predicted value based on the adaptive filtering solution provided in the foregoing aspect, and w indicates a weighting coefficient for performing a weighting operation on the two predicted values.

Implementations of the video processing method in some application scenarios in the aspects of this disclosure are described in detail below by using a decoding procedure performed by a video decoding end as an example.

In an application scenario, a video decoding end may perform decoding processing on a video stream, and determine, according to a decoding result, whether the IBC filtering method provided in the foregoing aspect of this disclosure is used for a current to-be-reconstructed image block (a coding block is used as an example). The following three implementations may be used for determining whether to use the IBC filtering method.

In a first implementation, the stream includes a high-layer syntax element indicating whether to use the IBC-APF, and it may be determined whether the IBC-APF can be used for a current block according to the high-layer syntax element. Syntax structures of related syntax elements are shown in Table 5.

TABLE 5
A high-layer syntax element indicating
whether to use the IBC-APF

| | |
|---|---|
| pic_ibc_flag | u (1) |
| if(PicIbcFlag) { | |
| pic_ibc_type | u (1) |
| } | |
| if(PicIbcFlag == 1 && PicIbcType == 0) | |
| { | |
| pic_ibc_apf_flag | u (1) |
| } | |

pic_ibc_flag represents an image-level intra block copy prediction flag, and the flag is a binary variable. A value ‘1’ indicates that the IBC mode may be used. A value ‘0’ indicates that the IBC mode is not used. A value of PicIbcFlag is equal to a value of pic_ibc_flag. If the stream does not include pic_ibc_flag, the value of PicIbcFlag is 0.

pic_ibc_type represents a type index of an image-level intra block copy prediction mode. A value ‘0’ indicates that the IBC mode of a first type can be used. A value ‘1’ indicates that the IBC mode of a second type is used. The value of PicIbc Type is equal to the value of pic_ibc_type. If the stream does not include pic_ibc_type, the value of PicIbc Type is 0.

pic_ibc_apf_flag represents an adaptive filtering flag of image-level intra block copy prediction, and the flag is a binary variable. A value ‘1’ indicates that the IBC adaptive filtering mode may be used. A value ‘0’ indicates that the IBC adaptive filtering mode is not used. The value of PiclbcApfFlag is equal to the value of pic_ibc_apf_flag. If the stream does not include pic_ibc_apf_flag, the value of PiclbcApfFlag is 0.

In a second implementation, the stream includes a high-layer syntax element to indicate whether to use IBC-PF (which is an IBC filtering method and may include a plurality of filtering manners), and it is determined whether to use IBC-PF according to the syntax element. Syntax structures of related syntax elements are shown in Table 6.

TABLE 6
A high-layer syntax element indicating whether to use IBC-PF

| | |
|---|---|
| pic_ibc_flag | u (1) |
| if(PicIbcFlag == 1) | |
| { | |
| pic_ibc_pf_index | u (1) |
| } | |

pic_ibc_flag represents an image-level intra block copy prediction flag, and the flag is a binary variable. A value ‘1’ indicates that the IBC mode can be used. A value ‘0’ indicates that the IBC mode is not used. A value of PicIbcFlag is equal to a value of pic_ibc_flag. If the stream does not include pic_ibc_flag, the value of PicIbcFlag is 0.

pic_ibc_pf_index represents a filtering index of image-level intra block copy prediction, and the index is a binary variable. A value ‘0’ indicates that the IBC filtering mode of a first type may be used. A value ‘1’ indicates that the IBC filtering mode of a second type may be used. The value of PicIbcPfFlag is equal to the value of pic_ibc_pf_flag. If the stream does not include pic_ibc_pf_flag, the value of PicIbcPfFlag is 0.

In a third implementation, a block-level identifier included in the stream is obtained by decoding the stream, where the block-level identifier is used to indicate whether to perform filtering processing on the current block.

In some application scenarios, the block-level identifier is decoded when, or only when, a preset decoding condition is satisfied. For example, the decoding condition may include one or more of the following conditions:

In condition (1), it is determined, according to high-level syntax information of an image header, that the IBC-APF mode can be used for a current image.

In condition (2), an area (width*height) of the current block is greater than 32.

In condition (3), a location coordinate (a horizontal coordinate and/or a vertical coordinate) of the current block is greater than or equal to a threshold.

The threshold may be determined according to a template size. The template size is set to tpl_size (for example, a value of 4), and the template size indicates a height of a template above an image block or a width of a template on the left.

The threshold is determined according to a partition tree type (including a luminance tree, a chrominance tree, and a luminance-chrominance tree) of the current block. If the partition tree type is a luminance tree, the threshold is determined as tpl_size. If the current block includes the chrominance tree, the threshold is tpl_size*scale_ratio. The scale_ratio is determined according to an image color format. For example, for an image in a YUV420 format, if the length and the width of the luminance component are twice those of the chrominance component, the scale_ratio is 2, that is, the threshold is tpl_size*2.

In some application scenarios, a flag of cu_ibc_pf_flag, or in some examples only the flag, may be used to indicate an IBC-APF mode used for a current block, and semantic information corresponding to the flag of cu_ibc_pf_flag in different values is shown in Table 7.

TABLE 7
Semantic information corresponding to the flag of cu_ibc_pf_flag

| cu_ibc_pf_flag | Semantics |
|---|---|
| 0 | An IBC-PF mode is not used |
| 1 | An IBC-APF mode is used (templates above and |
| | on the left are used) |
| 2 | An IBC-APF mode is used (a template above |
| | is used) |
| 3 | An IBC-APF mode is used (a template on the |
| | left is used) |

In some application scenarios, the stream further includes a flag of ibc_type (which may be a sequence-level, image-level, slice-level, or block-level flag) that indicates a filtering type, and when ibc_type has different values, different filtering manners are used. Semantic information corresponding to the flag of ibc_type and the flag of cu_ibc_pf_flag in different values is shown in Table 8.

TABLE 8
Semantic information corresponding to flag of
ibc_type and flag of cu_ibc_pf_flag

| ibc_type | cu_ibc_pf_flag | Semantics |
|---|---|---|
| 0 | 0 | An IBC-PF mode is not used |
| 0 | 1 | An IBC-PF mode 1 is used |
| 0 | 2 | An IBC-PF mode 2 is used |
| 1 | 0 | An IBC-PF mode is not used |
| 1 | 1 | An IBC-APF mode is used (templates |
| | | above and on the left are used) |
| 1 | 2 | An IBC-APF mode is used (a template |
| | | above is used) |
| 1 | 3 | An IBC-APF mode is used (a template |
| | | on the left is used) |

Truncated unary code may be used as a binarization/de-binarization method of the flag.

If it is determined that the IBC-APF is used for the current block, a filter is determined according to the following method, and filtering processing is performed on the IBC predicted value of the current block based on the filter.

The filter model of the IBC-APF may be represented as follows in equation (15)

$$y = p 0 ⋆ x 0 + p 1 * x 1 + p 2 ⋆ x 2 + … + pn ⋆ xn . \qquad Eq . ( 15 )$$

where {p0, p1, . . . , pn} are filter parameters, {x0, x1, . . . , xn} are input values, and y is an output value. xi (i=0, . . . , n) is derived based on a reference sample and an adjacent sample corresponding to the current to-be-filtered sample.

Using a sample shown in FIG. 7A as an example, a center C of the filter is a reference sample determined for a current to-be-filtered sample C′ according to a block vector. N, S, W, E, NW, NE, SW, and SE respectively represent samples in locations above, below, on the left, the right, the upper left, the upper right, the lower left, and the lower right of a spatial location of the sample C.

The shape of the filter may be padded into other shapes (including but not limited to various shapes shown in FIG. 8), and the center of the filter is located in a reference sample determined for a current to-be-filtered sample according to a block vector.

Assuming that Rj represents an input of the filter, xi may be any combination of Rj, such as at least one of Rj, m*Rj, Rj^{k}, and a constant bias term B, or may be a combination term of multiplication and addition of any of these terms. Herein, m and k are non-zero integers. K is an integer greater than 1.

In some application scenarios, one or more candidate models may be selected for the filter. The one or more candidate models may be provided as follows in equation (16)-(31)

$$y = {p}_{0} C + {p}_{1} N + {p}_{2} S + {p}_{3} W + {p}_{4} E + {p}_{5} {C}^{2} + {p}_{6} B \qquad Eq . ( 16 )$$

$$y = {p}_{0} C + {p}_{1} N + {p}_{2} S + {p}_{3} W + {p}_{4} E + {p}_{5} B \qquad Eq . ( 17 )$$

$$y = {p}_{0} C + {p}_{1} ( N + S ) + {p}_{2} ( W + E ) + {p}_{3} B \qquad Eq . ( 18 )$$

$$y = {p}_{0} C + {p}_{1} ( N + W ) + {p}_{2} ( W + E ) + {p}_{3} B \qquad Eq . ( 19 )$$

$$y = {p}_{0} C + {p}_{1} N + {p}_{2} S + {p}_{3} B \qquad Eq . ( 20 )$$

$$y = {p}_{0} C + {p}_{1} E + {p}_{2} W + {p}_{3} B \qquad Eq . ( 21 )$$

$$y = {p}_{0} C + {p}_{1} B \qquad Eq . ( 22 )$$

$$y = {p}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {{p}_{5} ( \frac{N + S + 4 C + W + E}{8} )}^{2} + {p}_{6} B \qquad Eq . ( 23 )$$

$$y = {p}_{0} ( \frac{N + S + 4 C + W + E}{8} ) + {p}_{1} ( \frac{N + W}{2} ) + {p}_{2} ( \frac{N + E}{2} ) + {p}_{3} ( \frac{S + W}{2} ) + {p}_{4} ( \frac{S + E}{2} ) + {p}_{5} B \qquad Eq . ( 24 )$$

$$y = {p}_{0} ( \frac{N + S + 4 C + W + E}{8} ) + {p}_{1} ( \frac{N + W}{2} ) + {p}_{2} ( \frac{S + E}{2} ) + {p}_{3} B \qquad Eq . ( 25 )$$

$$y = {p}_{0} ( \frac{N + S + 4 C + W + E}{8} ) + {p}_{1} ( \frac{N + S}{2} ) + {p}_{2} ( \frac{S + W}{2} ) + {p}_{3} B \qquad Eq . ( 26 )$$

$$y = {p}_{0} ( \frac{N + S + 4 C + W + E}{8} ) + {p}_{1} ( \frac{N + W + S + E}{4} ) + {p}_{2} B \qquad Eq . ( 27 )$$

$$y = {p}_{0} ( \frac{N + S + 4 C + W + E}{8} ) + {p}_{1} ( \frac{N + W + S + E}{4} ) + {p}_{2} B \qquad Eq . ( 28 )$$

$$y = {p}_{0} ( \frac{N + S + 4 C + W + E}{8} ) + {p}_{1} ( \frac{N + S}{2} ) + {p}_{2} B \qquad Eq . ( 29 )$$

$$y = {p}_{0} ( \frac{N + S + 4 C + W + E}{8} ) + {p}_{1} ( \frac{E + W}{2} ) + {p}_{2} B \qquad Eq . ( 30 )$$

$$y = {p}_{0} ( \frac{N + S + 4 C + W + E}{8} ) + {p}_{1} B \qquad Eq . ( 31 )$$

Based on the foregoing filter model, y is used as a sample in the template region of the current block, and an input is a sample in a template region of the corresponding reference block, to generate an equation. A plurality of such equations are constructed by using samples in the template region to solve model parameters pᵢ. A model parameter solving process may be coupled to a coding and decoding process, that is, a model parameter is calculated online for each coding block by using an adjacent template.

FIG. 15 is a schematic diagram of distribution of a template region used in an application scenario according to an aspect of this disclosure. The template region may be all adjacent regions of an image block shown in the figure.

For example, a template above+a template on the left indicates that the template region includes adjacent regions A, B, and D above and on the left of the image block.

The template above indicates that the template region includes an adjacent region B above the image block.

The template on the left indicates that the template region includes an adjacent region D on the left of the image block.

A size of the region B is (blk_w, 2), and a size of the region D is (2, blk_h). blk_w represents a width of the image block, and blk_h represents a height of the image block.

In some application scenarios, a plurality of templates may exist at the same time, and a template to be used is determined according to a stream parsing result. For example, a plurality of templates shown in FIG. 14 exist at the same time. When a value of a first syntax element is 1 in the stream, it indicates that a full region combination template (LT type) is used. When the value of the first syntax element is 0, it indicates that the LT type is not used. The stream continues to be decoded when the first syntax element is 0, to determine whether there is another template. When a value of a second syntax element in the stream is 01, it indicates that a left region combination template (L type) is used. When the value of the second syntax element is 00 in the stream, it indicates that an upper region combination template (T type) is used.

After the filter is determined, the boundary of the template used as an input is padded according to the shape of the filter.

For example, when the shape 1 shown in FIG. 8 is used for the filter, four adjacent pixels N, S, W, and E around the central sample C need to be used. In this case, the template may be padded by 1 unit.

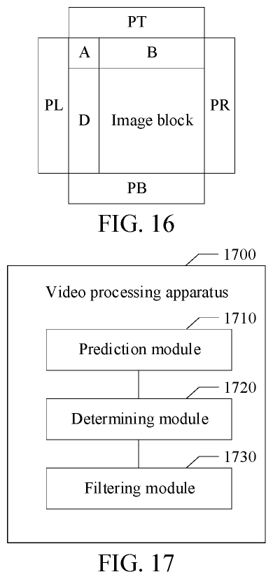

FIG. 16 is a schematic diagram of template region padding in an application scenario according to an aspect of this disclosure.

As shown in FIG. 16, the original template region includes adjacent regions A, B, and D located above and on the left of the image block. After the template region is padded, corresponding padded regions PT, PL, PB, and PR may be determined.

Widths of PT and PB are equal to a width of the image block+a width of the region D/the region A. Heights of PL and PR are equal to a height of the image block+a height of the region B/the region A.

Heights of PT and PB are pad_size, and widths of PL and PR are pad_size. pad_size is a size determined according to the shape of the filter. For example, if the filter needs to use a pixel that is one unit away from the central location, a value of pad_size is 1.

For some regions (for example, PT and PL) in {PT, PB, PR, PL}, it is first determined whether the regions are located in an available reconstructed region (for example, within boundary of an image). If yes, values of the regions are used; otherwise, the values of the regions are set to a value of a reconstructed sample adjacent to the regions. For example, a value of PT is set to a value of a sample below, and a value of PL is set to a value of a sample on the right.

For some regions (for example, PR and PB) in {PT, PB, PR, PL}, values of the regions are set to a value of a reconstructed sample adjacent to the regions. For example, a value of PR is set to a value of a sample on the left, and a value of PB is set to a value of a sample above.

All samples in the template region are used to calculate model parameters of the filter model.

According to the samples that can be used in the template region, a plurality of equations may be established for the filter model, for example, Ax=b. By solving x, values of all model parameters pᵢ may be obtained. A is a matrix with M rows and N columns, and M and N respectively represent a quantity of equations and a quantity of model parameters established according to a template. There are many methods for solving this equation, for example, the LDL decomposition method or the Gaussian elimination method. An example of the LDL decomposition method is applied according to steps (1)-(4) as follows:

At step (1), A^{T}Ax=A^{T}b. A^{T} is a transpose matrix of a matrix A.

At step (2), A^{T}A is decomposed to obtain LDL^{T}x=A^{T}b. L is a unit lower triangular matrix, D is a diagonal matrix, and L^{T} is a transpose matrix of L.

At step (3), LY=A^{T}b is solved to obtain Y.

At step (4), DL^{T}x=Y is solved to obtain x, that is, the model parameter pᵢ.

After solving of the model parameter is completed, the IBC predicted value (or an intermediate value obtained by modifying the IBC predicted value) may be filtered according to the filter model. An IBC predicted value of the current block (a value of the reference block) is used as an input, and boundary of the reference block is padded according to a filtering shape, to filter samples in the boundary of the reference block. The boundary pixel may be directly copied, and if boundary samples are available, the boundary samples may be directly used. Then, the exported model parameter is used for filtering.

As shown in FIG. 7C, a sample in the reference block is C, and a sample in the current block is C′. In the current block, an IBC predicted value corresponding to the sample C′ is a value of C. According to the method in an aspect of this disclosure, filtering processing is performed on a value of C′ by using a filter.

As can be known from the descriptions of the foregoing aspect and application scenarios, in the aspects of this disclosure, a filtering parameter may be adaptively calculated based on reconstructed regions adjacent to a current block and a reference block, to filter an IBC predicted block. Therefore, space domain discontinuity between the predicted block and surrounding pixels can be eliminated, and coding performance can be improved.

The operations of the method of this disclosure are described in a preset order in the accompanying drawings. However, this does not request or imply that the operations are performed according to the preset order, or all shown operations are necessarily performed to implement a desired result. Additionally or alternatively, some operations may be omitted, a plurality of operations may be combined into one operation for execution, and/or one operation may be decomposed into a plurality of operations for execution.

The following describes apparatus aspects of this disclosure, and the apparatus may be configured to perform the video processing method in the foregoing aspects of this disclosure. FIG. 17 is a structural block diagram of a video processing apparatus according to an aspect of this disclosure. As shown in FIG. 17, a video processing apparatus (or apparatus) (1700) includes a prediction module (1710), configured to perform intra block copy prediction on a current block according to a reference block of the current block, to obtain a first predicted value of the current block, the current block being a to-be-processed image block in a current video frame, and the reference block being a reconstructed image block in the current video frame;

The apparatus (1700) may include a determining module (1720), configured to determine a first template region of the reference block and a second template region of the current block, the first template region including one or more reconstructed image regions adjacent to the reference block, and the second template region including one or more reconstructed image regions adjacent to the current block; and

The apparatus (1700) may include a filtering module (1730), configured to: determine a filter according to the first template region and the second template region, and perform filtering processing on the first predicted value of the current block according to the filter, to obtain a second predicted value of the current block.

In some aspects of this disclosure, based on the foregoing aspects, the filtering module (1730) may be further configured to: obtain a filtering condition of the current block, where the filtering condition is used to determine whether to perform filtering processing on the current block; and perform filtering processing on the first predicted value of the current block according to the filter when the filtering condition is satisfied.

In some aspects of this disclosure, based on the foregoing aspects, the filtering condition includes at least one of the following conditions: (1) a stream parameter corresponding to the current block has a specified value; (2) an image feature of the current block satisfies a preset first feature condition; (3) an image feature of the reference block satisfies a preset second feature condition; and (4) an image feature of a template region satisfies a preset third feature condition, where the template region includes the first template region and the second template region.

In some aspects of this disclosure, based on the foregoing aspects, the stream parameter includes a filtering flag, the filtering flag is used to indicate whether to perform filtering processing on an image block, and the filtering flag includes one or more of the following flags: a sequence header filtering flag, used to indicate whether to perform filtering processing on an image block in a video frame sequence; an image header filtering flag, used to indicate whether to perform filtering processing on an image block in a video frame; a slice header filtering flag, used to indicate whether to perform filtering processing on an image block in an image slice; and a block-level filtering flag, used to indicate whether to perform filtering processing on the current block.

In some aspects of this disclosure, based on the foregoing aspects, when the stream parameter includes the block-level filtering flag, the block-level filtering flag is decoded when a preset decoding condition is satisfied, and decoding of the block-level filtering flag is forbidden when the preset decoding condition is not satisfied.

In some aspects of this disclosure, based on the foregoing aspects, the stream parameter further includes a filtering index, the filtering index is used to indicate a filtering mode of filtering processing to be performed on the image block, and the filtering mode includes one or more different filtering methods.

In some aspects of this disclosure, based on the foregoing aspects, the filtering flag is further used to indicate a filtering mode of filtering processing to be performed on the image block, and the filtering mode includes one or more different filtering methods.

In some aspects of this disclosure, based on the foregoing aspects, the stream parameter further includes a filtering type field used to indicate a filtering type; and when a value of the filtering type field is a first value, the filtering flag is used to indicate whether to perform filtering processing on the image block and indicate that a filtering mode of filtering processing to be performed on the image block is a preset first mode; and when a value of the filtering type field is a second value, the filtering flag is used to indicate whether to perform filtering processing on the image block and indicate that a filtering mode of filtering processing to be performed on the image block is a preset second mode, where the second mode is a filtering mode different from the first mode.

In some aspects of this disclosure, based on the foregoing aspects, the value of the filtering flag is determined according to a coding loss, and the coding loss is calculated by using a preset cost function.

In an example, a first value is assigned to the filtering flag if a coding loss after filtering processing is performed on the template region of the image block is less than a coding loss before filtering processing is performed on the template region of the image block, where the first value is used to indicate to perform filtering processing on the image block; and

In an example, a second value is assigned to the filtering flag if the coding loss after filtering processing is performed on the template region of the image block is greater than the coding loss before filtering processing is performed on the template region of the image block, where the second value is used to indicate to forbid filtering processing on the image block.

In some aspects of this disclosure, based on the foregoing aspects, a value of the filtering flag is determined according to a quantity of transform coefficients in the image block.

A first value is assigned to the filtering flag if the transform coefficient in the image block satisfies a preset first quantity condition, where the first value is used to indicate to perform filtering processing on the image block; and a second value is assigned to the filtering flag if the transform coefficient in the image block satisfies a preset second quantity condition, where the second value is used to indicate to forbid filtering processing on the image block.

In some aspects of this disclosure, based on the foregoing aspects, the first feature condition includes one or more of the following conditions: the current video frame in which the current block is located has a specified image type; the current block has a specified distribution location in the current video frame; an image size of the current block falls within a preset size range, where the image size includes one or more of a width, a height, or an area; a block vector resolution of the current block falls within a preset resolution range; a block vector residual of the current block falls within a preset residual range, where the block vector residual includes one or more of a horizontal block vector residual or a vertical block vector residual; a block vector index of the current block falls within a preset index range; and the current block is an image block having a specified color component.

In some aspects of this disclosure, based on the foregoing aspects, the second feature condition includes: a sample of the reference block satisfies a preset sample available condition, where the sample available condition includes that the sample is located within boundary of an independently decodable image or decoding and reconstruction of the sample have been completed.

In some aspects of this disclosure, based on the foregoing aspects, the third feature condition includes one or more of the following conditions: an area of the template region falls within a preset area range; a sample of the template region satisfies a preset sample available condition, where the sample available condition includes that the sample is located within boundary of an independently decodable image or decoding and reconstruction of the sample have been completed; and a quantity of sample pairs collected in the template region is greater than a quantity of model parameters of the filter.

In some aspects of this disclosure, based on the foregoing aspects, the filtering module (1730) is further configured to: select a first sample from the first template region, and select a second sample corresponding to the first sample from the second template region; and determine a filter based on a sample pair formed by the first sample and the second sample, where an input item of the filter includes a pixel value of the first sample, an output item of the filter includes a pixel value of the second sample, and the pixel value includes a predicted value or a reconstructed value.

In some aspects of this disclosure, based on the foregoing aspects, the input item of the filter further includes a pixel value of one or more adjacent pixels, and the adjacent pixel is a pixel nearest to or next nearest to the first sample.

In some aspects of this disclosure, based on the foregoing aspects, the filter includes one or more combination items having independent weighting parameters, and the combination item uses pixel values of one or more pixels as input items.

In some aspects of this disclosure, based on the foregoing aspects, the filter includes at least two combination items with different orders, and the order is a highest power of an input item in the combination item.

In some aspects of this disclosure, based on the foregoing aspects, a method for selecting a sample from the template region includes: obtaining a pixel sampling mode of the current block, where the pixel sampling mode includes full pixel sampling or partial pixel sampling; selecting a pixel from all pixels in the template region as a sample when the pixel sampling mode of the current block is full pixel sampling; and selecting some pixels in a specified sampling location in the template region as samples when the pixel sampling mode of the current block is partial pixel sampling. A pixel is selected from all pixels in the first template region as the first sample, and a pixel is selected from all pixels in the second template region as the second sample when the pixel sampling mode of the current block is full pixel sampling; and a pixel is selected from some pixels in a first specified sampling location in the first template region as the first sample, and a pixel is selected from some pixels in a second specified sampling location in the second template region as the second sample when the pixel sampling mode of the current block is partial pixel sampling.

In some aspects of this disclosure, based on the foregoing aspects, the specified sampling location includes at least one of the following sampling locations: a specified sampling location whose pixel location coordinates satisfy a preset coordinate value condition; a specified sampling location selected along a preset pixel scanning direction; and a specified sampling location whose pixel value falls within a preset value range.

In some aspects of this disclosure, based on the foregoing aspects, the coordinate value condition includes: at least one of a horizontal location coordinate and a vertical location coordinate of a pixel is an even number; or at least one of the horizontal location coordinate and the vertical location coordinate of the pixel is an odd number.

In some aspects of this disclosure, based on the foregoing aspects, the template region is formed by combining one or more nearest regions or next nearest regions, the nearest region includes an image region that is located above or on the left of the image block and that has a specified image size, and the next nearest region includes an image region that is located on the upper left, the lower left, or the upper right of the image block and that has a specified image size.

In some aspects of this disclosure, based on the foregoing aspects, the next nearest region on the upper right of the image block has the same image size as the image block in a horizontal direction, the next nearest region on the upper right of the image block has a specified image size in a vertical direction, and the specified image size is greater than or equal to one; the next nearest region on the lower left of the image block has the same image size as the image block in a vertical direction, and the next nearest region on the upper right of the image block has a specified image size in a horizontal direction; and the next nearest region on the upper left of the image block has the specified image size in both a horizontal direction and a vertical direction.

In some aspects of this disclosure, based on the foregoing aspects, the template region includes at least one of a full region combination, a left region combination, and an upper region combination. In an example, the full region combination includes the nearest regions located on the left and above the image block and the next nearest regions located on the upper left, the lower left, and the upper right of the image block. In an example, the left region combination includes the nearest region located on the left of the image block and the next nearest region located on the lower left of the image block. In an example, the upper region combination includes the nearest region located above the image block and the next nearest region located on the upper right of the image block.

In some aspects of this disclosure, based on the foregoing aspects, the stream parameter corresponding to the current block includes a region type field, and the region type field is used to indicate a region type of a template region corresponding to the current block.

In some aspects of this disclosure, based on the foregoing aspects, the filtering module (1730) is further configured to: perform a weighting operation on the first predicted value and the second predicted value according to a preset weighting coefficient, to obtain a third predicted value of the current block.

Details of the video processing apparatus provided in the aspects of this disclosure are described in the corresponding method aspects and are not be described herein again.

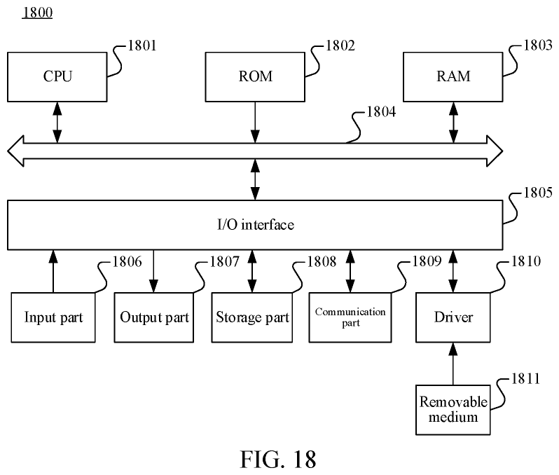

FIG. 18 is a structural block diagram of a computer system for implementing an electronic device according to an aspect of this disclosure.

A computer system (1800) of an electronic device shown in FIG. 18 is merely an example, and does not constitute any limitation on functions and use ranges of the aspects of this disclosure.

As shown in FIG. 18, the computer system (1800) includes a central processing unit (CPU) (1801), which may perform various suitable actions and processing according to a program stored in a read-only memory (ROM) (1802) or a program loaded from a storage part (1808) to a random access memory (RAM) (1803). The random access memory (1803) further stores various programs and data required by system operations. The central processing unit (1801), the read-only memory (1802), and the random access memory (1803) are connected to each other by using a bus (1804). An input/output interface (I/O interface) (1805) is also connected to the bus (1804).

The following components are connected to the I/O interface (1805): an input part (1806), including a keyboard, a mouse, and the like; an output part (1807), including a cathode ray tube (CRT), a liquid crystal display (LCD), a loudspeaker, and the like; the storage part (1808), including a hard disk, and the like; and a communication part (1809), including a network interface card such as a local area network card and a modem. The communication part (1809) performs communication processing by using a network such as the Internet. A drive (1810) is also connected to the input/output interface (1805) as required. A removable medium (1811), such as a magnetic disk, an optical disc, a magneto-optical disk, or a semiconductor memory, is installed on the drive (1810) as required, so that a computer program read from the removable medium is installed into the storage part (1808) as required.

For example, according to an aspect of this disclosure, the processes described in the method flowcharts may be implemented as computer software programs. For example, an aspect of this disclosure includes a computer program product, the computer program product includes a computer program carried on a computer-readable medium, and the computer program includes program code for performing the methods shown in the flowcharts. In such an aspect, the computer program may be downloaded and installed from a network through the communication part (1809), and/or installed from the removable medium (1811). When the computer program is executed by the central processing unit (1801), various functions defined in the system of this disclosure are executed.

The computer-readable medium according to the aspects of this disclosure may be a computer-readable signal medium, a computer-readable storage medium, or any combination of the two. The computer-readable storage medium may be, for example (but is not limited to) an electric, magnetic, optical, electromagnetic, infrared, or semi-conductive system, apparatus, or device, or any combination of the above. An example of the computer-readable storage medium may include but is not limited to: an electrical connection having one or more wires, a portable computer magnetic disk, a hard disk, a random access memory (RAM), a read-only memory (ROM), an erasable programmable read-only memory (EPROM), a flash memory, an optical fiber, a compact disk read-only memory (CD-ROM), an optical storage device, a magnetic storage device, or any appropriate combination thereof. In this disclosure, the computer-readable storage medium may be any tangible medium that includes or stores a program. The program may be used by an instruction execution system, apparatus, or device, or may be used with combination thereof. In this disclosure, the computer-readable signal medium may include a data signal being in a baseband or propagated as a part of a carrier wave, where the data signal carries computer-readable program code. A data signal propagated in such a way may have a plurality of forms, including but not limited to, an electromagnetic signal, an optical signal, or any appropriate combination of the above. The computer-readable signal medium may further be any computer-readable medium other than the computer-readable storage medium. The computer-readable medium may send, propagate, or transmit a program used by or in combination with the instruction execution system, apparatus, or device. The program code included in the computer-readable medium may be transmitted by using any suitable medium, including, but not limited to, a wireless medium, a wired medium, and the like, or any suitable combination of the above.

The flowcharts and block diagrams in the accompanying drawings illustrate possible system architectures, functions and operations that may be implemented by a system, a method, and a computer program product according to various aspects of this disclosure. In this regard, each block in the flowchart or the block diagram may represent a module, a program segment, or a part of code. The module, the program segment, or the part of the code includes one or more executable instructions for implementing a specified logical function. In some implementations used as substitutes, functions annotated in blocks may alternatively occur in a sequence different from that annotated in an accompanying drawing. For example, two blocks shown in succession may actually be performed basically in parallel, and sometimes the two blocks may be performed in a reverse order. This depends on the functions involved. Each block of the block diagrams or the flowcharts and combinations of blocks in the block diagrams or the flowcharts may be implemented by a dedicated hardware-based system that performs specified functions or operations, or may be implemented by a combination of dedicated hardware and a computer instruction.

Although several modules or units of a device configured to perform actions are discussed in the foregoing detailed description, such division is not mandatory. In practice, according to the implementations of this disclosure, the features and functions of two or more modules or units described above may be embodied by one module or unit. On the contrary, the features and functions of one module or unit described above may further be divided to be embodied by a plurality of modules or units.

According to the foregoing descriptions of the implementations, those skilled in the art may understand that the example implementations described herein may be implemented by using software, or may be implemented by software in combination with necessary hardware. Therefore, the technical solutions according to the implementations of this disclosure may be embodied in a form of a software product. The software product may be stored in a non-volatile storage medium (which may be a CD-ROM, a USB flash drive, a removable hard disk, or the like) or on the network, including several instructions for enabling a computing device (which may be a personal computer, a server, a touch terminal, a network device, or the like) to perform the method according to the implementations of this disclosure.

After considering this specification and practicing the present disclosure, a person skilled in the art may conceive of other implementations of this disclosure. This disclosure is intended to cover any variations, usages, or adaptive changes of this disclosure. These variations, usages, or adaptive changes follow the general principles of this disclosure and include general knowledge or related technical means in the technical field not disclosed in this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

This disclosure is not limited to the precise structures described above and shown in the accompanying drawings, and various modifications and changes can be made without departing from the scope of this disclosure.

What is claimed is:

1. A method of video decoding, comprising:
performing intra block copy prediction on a current block according to a reference block of the current block, to obtain a first predicted value of the current block, the current block being a to-be-processed image block in a current video frame, and the reference block being a reconstructed image block in the current video frame;
determining a first template region of the reference block and a second template region of the current block, the first template region including one or more reconstructed image regions adjacent to the reference block, and the second template region including one or more reconstructed image regions adjacent to the current block;
determining a filter according to the first template region and the second template region;
performing filtering processing on the first predicted value of the current block according to the filter, to obtain a second predicted value of the current block; and
reconstructing the current block based on a weighted combination of the first predicted value and the second predicted value.

2. The method according to claim 1, wherein the performing the filtering processing comprises:
determining whether the current block satisfies a filtering condition; and
performing the filtering processing on the first predicted value of the current block when the filtering condition is satisfied,
wherein the filtering condition indicates at least one of:
a stream parameter related to the current block has a specified value;
an image feature of the current block satisfies a preset first feature condition;
an image feature of the reference block satisfies a preset second feature condition; or
an image feature of a template region satisfies a preset third feature condition, the template region including one of the first template region and the second template region.

3. The method according to claim 2, wherein:
the stream parameter includes a filtering flag,
the filtering flag indicates whether the filtering processing is performed on an image block in the current video frame, and
the filtering flag indicates one of:
a sequence header filtering flag that indicates whether the filtering processing is performed on the image block when the image block is in a video frame sequence;
an image header filtering flag that indicates whether the filtering processing is performed on the image block when the image block is in a video frame;
a slice header filtering flag that indicates whether the filtering processing is performed on the image block when the image block is in an image slice; and
a block-level filtering flag that indicates whether the filtering processing is performed on the current block when the image block is the current block.

4. The method according to claim 3, wherein the block-level filtering flag is decoded when a preset decoding condition is satisfied, and the block-level filtering flag is not decoded when the preset decoding condition is not satisfied.

5. The method according to claim 4, wherein the preset decoding condition indicates one of:
a high-layer syntax element in the stream parameter indicates the filtering processing is performed on the image block, the high-layer syntax element including at least one of the sequence header filtering flag, the image header filtering flag, and the slice header filtering flag;
an area of the current block falls within a preset value range;
location coordinates of the current block fall within a preset coordinate range;
a region range occupied by a reference region of the current block in the current video frame satisfies a preset range limit, the reference region including at least one of the current block, the second template region of the current block, or an extension region of the second template region; and
the reference region of the current block satisfies a reference range limit of the intra block copy prediction.

6. The method according to claim 5, wherein:
the preset coordinate range is a coordinate threshold; and the method further comprises:
determining the coordinate threshold according to a preset fixed value; or
determining the coordinate threshold according to a template size of the template region, the template size being a height of the template region when the template region is positioned at a top side of the current block, the template size being a width of the template region when the template region is positioned at a left side of the current block.

7. The method according to claim 6, wherein the determining the coordinate threshold according to the template size of the template region comprises one of:
applying the template size of the template region as the coordinate threshold when the current block does not include a chrominance component; and
determining a weighting coefficient according to a sampling ratio of a luminance component to a chrominance component when the current block includes the chrominance component, a product of the weighting coefficient and the template size of the template region being the coordinate threshold.

8. The method according to claim 2, wherein the stream parameter further includes a filtering index, the filtering index indicates a filtering mode of the filtering processing that is to be performed on the image block, and the filtering mode includes one or more filtering methods.

9. The method according to claim 3, wherein the filtering flag indicates a filtering mode of the filtering processing that is to be performed on the image block, and the filtering mode includes one or more different filtering methods.

10. The method according claim 3, wherein:
the stream parameter further includes a filtering type field indicating a filtering type;
when a value of the filtering type field is a first value, the filtering flag indicates (i) whether the filtering processing is performed on the image block and (ii) whether a filtering mode of the filtering processing that is to be performed on the image block is a preset first mode; and
when the value of the filtering type field is a second value, the filtering flag indicates (i) whether the filtering processing is performed on the image block and (ii) whether the filtering mode of the filtering processing that is to be performed on the image block is a preset second mode.

11. The method according to claim 3, wherein:
a value of the filtering flag is determined according to a coding loss that is calculated by using a preset cost function;
a first value is assigned to the filtering flag when a value of the coding loss that is determined after the filtering processing is performed on the template region of the image block is less than a value of the coding loss that is determined before the filtering processing is performed on the template region of the image block, the first value indicating that the filtering processing is to be performed on the image block; and
a second value is assigned to the filtering flag when the value of the coding loss that is determined after the filtering processing is performed on the template region of the image block is greater than the value of the coding loss that is determined before filtering processing is performed on the template region of the image block, the second value indicating that the filtering processing is not to be performed on the image block.

12. The method according to claim 3, wherein:
a value of the filtering flag is determined according to a quantity of transform coefficients in the image block;
a first value is assigned to the filtering flag when the quantity of the transform coefficients in the image block satisfies a preset first quantity condition, the first value indicating that the filtering processing is to be performed on the image block; and
a second value is assigned to the filtering flag when the quantity of the transform coefficient in the image block satisfies a preset second quantity condition, the second value indicating that the filtering processing is not to be performed on the image block.

13. The method according to claim 2, wherein the first feature condition indicates one of:
the current video frame in which the current block is located has a specified image type;
the current block has a specified distribution location in the current video frame;
an image size of the current block falls within a preset size range, the image size including at least one of a width, a height, or an area;
a block vector resolution of the current block falls within a preset resolution range;
a block vector residual of the current block falls within a preset residual range, the block vector residual including at least one of a horizontal block vector residual or a vertical block vector residual;
a block vector index of the current block falls within a preset index range; and
the current block has a specified color component.

14. The method according to claim 2, wherein
the second feature condition indicates a sample of the reference block satisfies a preset sample available condition, and
the sample available condition indicates that the sample of the reference block is located within a boundary of an independently decodable image of the current video frame or the sample has been decoded and reconstructed.

15. The method claim 2, wherein the third feature condition indicates one of:
an area of the template region falls within a preset area range;
a sample of the template region satisfies a preset sample available condition, the sample available condition indicating that the sample of the template region is located within a boundary of an independently decodable image of the current video frame or the sample has been decoded and reconstructed; and
a quantity of a plurality of sample pairs collected in the first template region and the second template region is greater than a preset quantity threshold, the preset quantity threshold indicating a quantity of model parameters in the filter.

16. The method according claim 1, wherein the determining the filter according to the first template region and the second template region comprises:
selecting a first sample from the first template region, and a second sample corresponding to the first sample from the second template region, a first pixel value of the first sample being used as an input item of the filter, and a second pixel value of the second sample being used as as an output item of the filter; and
determining a parameter of the filter according to the first pixel value of the first sample and the second pixel value of the second sample, each of the first pixel value and the second pixel value being a respective predicted value or a respective reconstructed value.

17. The method according to claim 16, wherein the input item of the filter further includes a pixel value of an adjacent pixel, and the adjacent pixel being a pixel nearest to or next nearest to the first sample from the first template region.

18. The method according to claim 17, wherein:
the input item of the filter includes a combination item, the combination item including one of (i) a first sum of pixel values of a first group of adjacent pixels from the first template region over a constant value with a first order, (ii) the first sum of the pixel values of the first group of adjacent pixels from the first template region over the constant value with a second order, (iii) a product of the first sum of the pixel values of the first group of adjacent pixels from the first template region over the constant value with the first order and a second sum of pixels values of a second group of adjacent pixels from the first template region over the constant value with the first order, and (iv) the pixel value of the adjacent pixel with the second order.

19. The method according to claim 16, wherein the selecting comprises:
obtaining a pixel sampling mode of the current block, the pixel sampling mode including a full pixel sampling or a partial pixel sampling;
selecting a pixel from pixels in the first template region as the first sample, and a pixel from pixels in the second template region as the second sample when the pixel sampling mode of the current block is the full pixel sampling; and
selecting a pixel from a subset of the pixels in a first specified sampling location in the first template region as the first sample, and a pixel from a subset of the pixels in a second specified sampling location in the second template region as the second sample when the pixel sampling mode of the current block is the partial pixel sampling.

20. The method according to claim 19, wherein:
the first specified sampling location and the second specified sampling location indicate at least one:
a specified sampling location with pixel location coordinates satisfying a preset coordinate value condition, the preset coordinate value condition indicating one of (i) at least one of a horizontal location coordinate and a vertical location coordinate of a pixel being an even number and (ii) at least one of the horizontal location coordinate and the vertical location coordinate of the pixel being an odd number;
a specified sampling location selected along a preset pixel scanning direction; and
a specified sampling location with pixel value falling within a preset value range.
